(19) United States
(12) Patent Application Publication
(10) Pub. No.: US 2012/0016818 A1
(43) Pub. Date: Jan. 19, 2012

(54) Classification of Biological Samples Using Spectroscopic Analysis

(76) Inventors: Mark Hackett, Alexandria (AU); Peter Lay, Newtown (AU); Elizabeth Carter, Marrickville (AU); Nicholas Hunt, Newtown (AU); Geoges Grau, Canada Bay (AU); David Gottlieb, Wollstonecraft (AU)

(21) Appl. No.: 13/124,208

(22) PCT Filed: Oct. 30, 2009
(86) PCT No.: PCT/AU09/01423

§ 371 Date: Oct. 4, 2011

(30) Foreign Application Priority Data
Oct. 31, 2008 (AU) 2008905640

(51) Int. Cl. G06F 15/18; G06N 5/04

(52) U.S. Cl. 706/12; 706/52

(57) ABSTRACT

A method and system is described for rapidly classifying a sample of a biological fluid, comprising obtaining a spectrum of the biological fluid in response to excitation of the sample in a specified frequency range, and applying a multivariate classifier to one or more spectral regions of the spectrum to classify the biological sample into one class in a set of classes, the classes comprising at least two disease states having similar clinical symptoms. Methods and systems for developing the classifiers are also described. In one example the classification uses a vibrational spectrometer (5) to provide spectra from serum. The multivariate classifier may run on processor (9) to distinguish between disease states having similar clinical symptoms, such as malaria and cerebral malaria.

### FIELD OF THE INVENTION

The present invention relates to methods and apparatus far classifying biological samples such as serum and plasma using spectroscopic analysis, and in particular to classification for diagnostic purposes,

### BACKGROUND OF THE INVENTION

There are many diseases for which no rapid diagnostic analysis is currently available. For some rapidly-progressing diseases the lack of a rapid diagnosis may mean the difference between life and death. Difficulties also arise in diagnosis where different diseases present symptoms that are clinically similar. An example of such diseases is cerebral malaria and acute bacterial meningitis. Another example is acute bacterial meningitis and acute viral meningitis.

Malaria is a major longstanding global health problem, affecting over 40% of the world's population across some 100 countries. Cerebral malaria (CM) is a debilitating neurological complication of infection with the malarial parasite P. falciparum, for which there is no specific treatment. Although only around 1% of P. falciparum infections progress to CM, it is still responsible for the death of up to two million children under the age of 5 each year. In the absence of CM, fatalities still result from other complications such as severe malarial anaemia, hyperglycaemia and acidosis induced respiratory distress. There is a high incidence of irreversible neurological impairment among survivors of CM.

Prompt identification of cerebral complications from other malarial complications and/or diseases, followed by urgent medical treatment including anti-malarial drugs is a critical factor in minimising CM fatalities and irreversible brain damage. However, there is no existing diagnostic method specific for CM. It is currently identified by the exclusion of other encephalopathies in patients with unrousable coma and confirmed P. falciparum infection. Thus, discrimination between the early stages of CM and other malarial complications is difficult. Further, acute bacterial meningitis (ABM) has similar clinical symptoms to CM (such as impaired consciousness). In malarial endemic regions, misdiagnosis between CM and ABM is common and contributes significantly to the morbidity and mortality of both diseases.

ABM is an invasive bacterial infection of the central nervous system which triggers a powerful inflammatory response capable of mediating significant neuronal damage. ABM is an unresolved medical issue in both developed and developing countries. The bacteria Streptococcus pneumoniae remains the leading cause of ABM in developed nations while H. influenzae is the predominant cause of ABM in developing nations. The number of fatalities due to ABM are row in comparison to malaria (approximately 600,000 cases of ABM each year, with 180,000 deaths and 75,000 cases of neurological sequelae). However, these statistics represent mortality rates of 30% with up to 50% of ABM survivors suffering long term neurological sequelae. These statistics result in considerable economic damage in developed (as well as developing) countries.

As with CM, a conclusive diagnosis of ABM can be problematic. Clinical diagnosis of ABM is traditionally obtained from a positive culture of pathogenic bacteria from cerebrospinal fluid (CSF). However, the results of this method for viral and bacterial disease cannot always accurately identify ABM. Further, bacteria culture is a time consuming method and the results are often not obtained in sufficient time to save the patient. Alternate methods, such as white blood cell counts in the CSF have been investigated, though there may be significant overlap in the range of white blood cell counts associated with CM and ABM. As such, the diagnosis of meningitis is a significant health and economic problem in developed countries. Furthermore, viral meningitis is difficult to distinguish clinically from bacterial meningitis. Appropriate treatment for bacterial meningitis includes antibiotics, whereas this is not useful in treating viral meningitis. Misdiagnosis of CM, bacterial meningitis and viral meningitis can lead to the administration of inappropriate therapies or withholding of the correct therapy. This leads to increased mortality, a higher incidence of long-term neurological sequelae and squandered health resources.

Reference to any prior art in the specification is not, and should not be taken as, an acknowledgment or any form of suggestion that this prior art forms part of the common general knowledge in Australia or any other jurisdiction or that this prior art could reasonably be expected to be ascertained, understood and regarded as relevant by a person skilled in the art.

### SUMMARY OF THE INVENTION

According to a first aspect of the invention there is provided a method of classifying a sample of a biological fluid comprising:

(a) obtaining a spectrum of the biological fluid in response to excitation of the sample in a specified frequency range; and

(b) applying a multivariate classifier to one or more spectral regions of the spectrum to classify the biological sample into one class in a set of classes, the classes comprising at least two disease states having similar clinical symptoms.

The disease states may be selected from the group consisting of:
bacterial meningitis;
cerebral malaria;
severe malaria anaemia;
mild malaria anaemia; and
healthy.

The disease states may comprise viral meningitis and bacterial meningitis.

The disease states may comprise graft-versus-host-disease (GVHD) and healthy. The GVHD disease state may be early-stage GVHD prior to the presentation of clinical symptoms,

The disease states may comprise Parkinson's disease and healthy.

The biological fluid may comprise a serum or a plasma.

The specified frequency range may be an infrared frequency range and the step of obtaining a spectrum may utilise at least one of Fourier Transform Infrared spectroscopy (FTIR) and Raman spectroscopy.

The spectral regions may include at least one of:
a fingerprint spectral region between 550 and 1490 cm⁻¹;
a C═O stretching spectral region between 1700 and 1760 cm⁻¹;
an amide spectral region between 1490 and 1700 cm⁻¹; and
a C—H stretching spectral region, between 2800 and 3100 cm⁻¹.

The multivariate classifier may comprise a hierarchical classification wherein the method comprises:
applying a first classifier to the spectrum to classify the sample into one class in a first set of classes; and, if the one class represents a plurality of sub-classes
applying a second classifier to the spectrum to classify the sample into one of the sub-classes.

The hierarchical classification may comprise further classifiers.

The first classifier may classify the sample into a sick class or a healthy class and the second classifier may classify samples from the sick class into i) a cerebral malaria class, ii) a bacterial meningitis class or iii) a severe malaria anaemia class.

According to a second aspect of the invention there is provided a method of classifying a biological sample comprising:

(a) obtaining a spectrum of the biological sample in response to excitation of the sample in a specified frequency range; and

(b) applying a multivariate classifier to the spectrum to classify the biological sample into one class in a set of classes, the classes comprising at least one disease caused by a pathogen.

According to another aspect of the invention there is provided a method of classifying a sample of a biological fluid comprising:

(a) obtaining a spectrum of the biological fluid in response to excitation of the sample in a specified frequency range; and

(b) applying a multivariate classifier to a plurality of spectral regions of the spectrum, wherein the classifier assigns a score for the biological fluid in each of the spectral regions;

(c) classifying the biological fluid into one class in a set of classes dependent on the assigned scores, the classes comprising at least one disease state selected from the group consisting of bacterial meningitis, cerebral malaria, mild malaria anaemia, severe malaria anaemia and healthy.

According to another aspect of the invention there is provided a method of classifying a sample of a biological fluid comprising:

(a) obtaining a spectrum of the biological fluid In response to excitation of the sample in a specified frequency, range; and

(b) applying a multivariate classifier to a plurality of spectral regions of the spectrum, wherein the classifier assigns a score for the biological fluid in each of the spectral regions;

(c) classifying the biological fluid into one class in a set of classes dependent on the assigned scores, the classes comprising i) healthy and ii) early-stage GVHD prior to the presentation of clinical symptoms.

According to another aspect of the invention there is provided a method of classifying a sample of a biological fluid comprising:

(a) obtaining a spectrum of the biological fluid in response to excitation of the sample in at least one specified frequency range; and

(b) applying a multivariate classifier to the at least one frequency range, wherein the classifier assigns one or more scores for the biological fluid in the at least one frequency range;

(c) classifying the biological fluid Into one class in a set of classes dependent on the assigned scores, the classes comprising i) healthy and ii) meningitis prior to the onset of clinical symptoms.

According to another aspect of the invention there is provided a method of classifying a sample of a biological fluid comprising:

(a) obtaining a spectrum of the biological fluid in response to excitation of the sample in a specified frequency range; and

(b) applying a multivariate classifier to a plurality of spectral regions of the spectrum, wherein the classifier assigns one or more scores for the biological fluid in each of the spectral regions;

(c) classifying the biological fluid into one class in a set of classes dependent on the assigned scores, the classes comprising i) healthy and ii) Parkinson's disease.

According to another aspect of the invention there is provided a method for rapidly diagnosing a malarial state of a patient, comprising:

(a) obtaining a blood sample from the patient;

(b) measuring a vibrational spectrum of serum from the blood sample;

(c) applying a multivariate classifier to a plurality of spectral regions of the vibrational spectrum, wherein the classifier assigns a score for the patient in each of the spectral regions;

(d) classifying the patient into one class in a set of malarial classes dependent on the assigned scores, the set of malarial classes comprising cerebral malaria, mild malaria anaemia, severe malaria anaemia and healthy.

According to another aspect of the invention there is provided method of classifying a sample of a biological fluid to assess progression of a disease, the method comprising:

(a) obtaining a spectrum of the biological fluid In response to excitation of the sample in at least one specified frequency range; and

(b) applying a multivariate classifier to the at least one frequency range, wherein the classifier assigns one or more scores for the biological fluid in the at least one frequency range;

(c) classifying the biological fluid into one class in a set of classes dependent on the assigned scores, the classes comprising different stages of the disease.

The disease may be meningitis.

The classes may comprise a plurality of different diseases and, for at least one of the diseases, a plurality of classes indicative of different stages of the at least one disease,

The plurality of diseases may include cerebral malaria, severe malaria and bacterial meningitis.

According to another aspect of the invention there is provided a method of determining a multivariate classifier for classifying samples of a biological fluid, comprising:

(a) obtaining a spectrum in a specified frequency range of each of a plurality of training biological fluid samples in response to excitation of the training fluid samples;

(b) associating a clinical characterisation with each of the spectra, wherein the clinical characterisation is drawn from a set comprising at least two disease states having similar clinical symptoms;

(c) performing a multivariate statistical analysis of a plurality of spectral regions of the spectra to identify distinguishing features of the spectra;

(d) defining a multivariable classifier that partitions the spectra into a plurality of classes dependent on the distinguishing features; and

(e) assessing whether the partitioning of the spectra by the multivariate classifier correlates to the respective clinical characterisations associated with the spectra.

The method may comprise defining a hierarchical classifier having a first classifier that partitions the spectra into a first set of classes and a second classifier that partitions at least one class from the first set into a second set of classes.

According to another aspect of the invention there is provided a method of determining a multivariate classifier for classifying biological samples, comprising:

(a) obtaining a spectrum of each of a plurality of training biological samples in response to excitation of the training samples in a specified frequency range;

(b) associating a clinical characterisation with each of the spectra, wherein the clinical characterisation is drawn from a set comprising at least one disease caused by a pathogen;

(c) performing a multivariate statistical analysis of the spectra to identify distinguishing features of the spectra;

(d) defining a multivariable classifier that partitions the spectra into a plurality of classes dependent on the distinguishing features; and

(e) assessing whether the partitioning of the spectra by the multivariate classifier correlates to the respective clinical characterisations associated with the spectra.

According to another aspect of the invention there is provided a method of determining a multivariate classifier for classifying biological samples dependent on at least one disease, comprising:

(a) obtaining a spectrum of each of a plurality of training biological samples in response to excitation of the training samples in a specified frequency range, the training samples including samples from subjects having the at least one disease;

(b) associating a clinical characterisation with each of the spectra;

(c) performing a multivariate statistical analysis of the spectra to remove variations in the plurality of training samples due to natural variations in the samples and identify distinguishing features dependent on the at least one disease;

(d) defining a multivariable classifier that partitions the spectra into a plurality of classes dependent on the distinguishing features; and

(e) assessing whether the partitioning of the spectra by the multivariate classifier correlates to the respective clinical characterisations associated with the spectra.

According to another aspect of the invention there is provided a method of determining a multivariate classifier for classifying samples of serum, comprising:

(a) obtaining a spectrum of each of a plurality of training serum samples in response to excitation of the training samples in an infrared specified frequency range, the training samples including samples from subjects having at least one disease state selected from the group consisting of acute bacterial meningitis, cerebral malaria, severe malaria anaemia, mild malaria anaemia and healthy;

(b) associating a clinical characterisation with each of the spectra;

(c) performing a multivariate analysis of the spectra to remove variations in the plurality of training samples due to natural variations in the samples and identify distinguishing features dependent on the at least one disease;

(d) defining a multivariable classifier that partitions the spectra into a plurality of classes dependent on the distinguishing features; and

(e) assessing whether the partitioning of the spectra by the multivariate classifier correlates to the respective clinical characterisations associated with the spectra.

According to another aspect of the invention there is provided a system for classifying a sample of a biological fluid comprising:
a spectrometer that provides a spectrum of the biological fluid in a specified frequency range; and
a processor having a multivariate classifier that in use is applied to one or more spectral regions of the spectrum to classify the biological sample into one class in a set of classes, the classes comprising at least two disease states having similar clinical symptoms.

The disease states may be selected from the group consisting of:
bacterial meningitis;
cerebral malaria;
severe malaria anaemia;
mild malaria anaemia; and
healthy.

The disease states may comprise viral meningitis and bacterial meningitis, or graft-versus-host-disease (GVHD) and healthy. The disease states may comprise Parkinson's disease and healthy.

The spectrometer may utilise Fourier Transform Infrared (FTIR) spectroscopy or Raman spectroscopy.

The invention also resides in instructions executable by a processor to implement the methods of classifying biological fluids and to such instructions when stored on a machine-readable recording medium for controlling the operation of a data processing apparatus on which the instructions execute.

The invention extends to a system for developing a classifier according to any one of the methods for developing a classifier summarised above.

As used herein, except where the context requires otherwise, the term “comprise” and variations of the term, such as “comprising”, “comprises” and “comprised”, are not intended to exclude further additives, components, integers or steps.

### BRIEF DESCRIPTION OF THE DRAWINGS

Embodiments of the invention are described below with reference to the drawings, in which:

FIG. 1A shows examples of average second derivative spectra (C—H stretching region of lipids, 3050-2800 cm⁻¹) of dried serum collected from mice suffering bacterial meningitis, cerebral malaria, mild malaria anaemia, severe malaria anaemia and healthy controls;

FIG. 1B shows examples of average second derivative spectra (C═O stretching region of lipids, 1760-1700 cm⁻¹) of dried serum collected from mice suffering bacterial meningitis, cerebral malaria, mild malaria anaemia, severe malaria anaemia and healthy controls;

FIG. 1C shows examples of average second derivative spectra (amide I & II region of proteins, 1700-1500 cm⁻¹) of dried serum collected from mice suffering bacterial meningitis, cerebral malaria, mild malaria anaemia, severe malaria anaemia and healthy controls;

FIG. 1D shows examples of average second derivative spectra (fingerprint region, C—O of carbohydrates, nucleic acids and lipids, 1200-950 cm⁻¹) of dried serum collected from mice suffering bacterial meningitis, cerebral malaria, mild malaria anaemia, severe malaria anaemia and healthy controls;

FIG. 2 shows an example of a 3D principal component score plot for the classification of bacterial meningitis versus cerebral malaria:

FIG. 3 shows an example of a 2D principal component score plot for the classification of bacterial meningitis versus severe malaria anaemia;

FIG. 4 shows an example of a 2D principal component score plot for the classification of bacterial meningitis versus mild malaria anaemia;

FIG. 5 shows an example of a 3D principal component score plot for the classification of bacterial meningitis versus healthy controls;

FIG. 6 shows an example of a 2D principal component score plot for the classification of cerebral malaria versus severe malaria anaemia;

FIG. 7 shows an example of a 2D principal component score plot for the classification of cerebral malaria versus mild malaria anaemia;

FIG. 8 shows an example of a 3D principal component score plot for the classification of cerebral malaria versus healthy controls;

FIGS. 9, 10A and 10B illustrate a hierarchical method of classification, in which FIG. 9 shows an example of a partial least squares (PLS) regression analysis of the CH stretching region (2800-3040 cm⁻¹) of FTIR spectra collected from dried mouse serum and separating sick and healthy mice;

FIG. 10A shows an example of a PLS regression analysis of the fingerprint region (700-1490 cm⁻¹) and C═O and amide region (1490-1800 cm⁻¹), of FTIR spectra collected from dried mouse serum and separating the sick mice into Cerebral Malaria, Malaria and meningitis;

FIG. 10B shows an example of a classification that refines the classification of FIG. 10A and indicates both a progression of meningitis and a diagnosis of CM, SM and ABM from PLS analysis on fingerprint, amide and C═O spectral region (800-1800 cm⁻¹);

FIG. 11A shows an alternative non-hierarchical method of classification using a single principal component plot with four classified regions based on infrared profiles of blood from mice with different pathologies;

FIG. 11B shows an example of Raman spectroscopic analysis of dried films of mouse serum, distinguishing between cerebral malaria and a control group;

FIG. 12 shows an example of PLS Regression analysis of the fingerprint region (700-1490 cm⁻¹), of FTIR spectra collected from dried mouse serum during the 40 hour time course of meningitis (N=5) development, the classification indicating the course of the disease;

FIG. 13 shows examples of infrared spectra corresponding to patients who had bone marrow transplants;

FIG. 14 shows a non-hierarchical principal component score plot derived from the spectra of FIG. 13 and showing a separation between patients who recovered and a patient who died of Graft-versus-host disease (GVHD);

FIG. 15A shows an example of a PLS regression analysis of the C═O and amide region (1490-1800 cm⁻¹) of FTIR spectra collected from human plasma and illustrating a classification of GVHD;

FIG. 15B shows an example of a PLS analysis of the amide/C═O region (1800-1490 cm⁻¹) of spectra collected from human plasma over the time course of skin GVHD development;

FIG. 15C shows an example of a PLS analysis of the C—H stretching region (2800-3100 cm⁻¹) of spectra collected from human plasma over the time course of liver GVHD development.

FIG. 16 shows an example of PLS regression analysis of the C—H stretching region (3100-2800 cm⁻¹), of FTIR spectra collected from human serum of patients suffering Parkinson's disease and age matched controls;

FIG. 17 shows an example of a PLS Regression analysis of fingerprint region (700-1490 cm⁻¹) and C═O and amide region (1490-1800 cm⁻¹), of FTIR spectra collected from dried human plasma (CM=Cerebral Malaria (n=10), SM=Severe Malaria (n=10), M=Mild Malaria (n=10), H=Controls (n10));

FIG. 18 shows an example of a 3D Principal component score plot (PC2, PC3, PC4), produced from PLS analyses of the C═O and amide regions (1800-1490 cm⁻¹) of human plasma (SM=Severe Malaria (n=10), CM=Cerebral Malaria (n=10));

FIG. 19 is a schematic diagram of a system that may be used in the development and application of a multivariate classifier based on vibrational spectroscopy; and

FIG. 20 is a flow chart illustrating a method of developing a multivariate classifier.

### DETAILED DESCRIPTION OF THE EMBODIMENTS

Embodiments of the methods described herein provide a rapid diagnosis of acute bacterial meningitis (ABM), cerebral malaria (CM) and malaria anaemia using infrared spectroscopic analysis of dried films of serum.

While CM and ABM are instigated by different pathogens, a number of similarities exist between their pathogenesis. Both CM and ABM involve cerebral complications due to the circulation of the pathogen through the cerebral microvasculature network (malarial parasite in CM, bacteria in ABM). In ABM the bacteria break through the microvasculature, invading the brain. In CM the parasite remains within the brain microvasculature. Postmortem findings from CM fatalities have identified the presence of sequestered parasitised red blood cells, (PRBCs) within brain microvessels. In addition to PRBCs, sequestered platelets and leukocytes also have been reported. Based on these findings two major theories exist to account for the pathogenesis of cerebral malaria. The first theory proposes that adherence of PRBCs to cerebral microvascular endothelium results in vascular obstruction, reduced cerebral oxygen consumption and tissue hypoxia. Findings of increased lactate, alanine and pyruvate concentrations (markers of anaerobic glycolysis, decreased tricarboxylic acid cycle activity and abnormal glucose metabolism) within the blood and CSF in human CM are thought to be consistent with this theory.

An alternative ‘cytokine’ theory proposes that parasite activation of immune cells mediates a severe host immunological cascade and induces the overproduction of host inflammatory cytokines. Some of these cytokines, such as tumor necrosis factor (TNF) are capable of inducing alterations in glucose metabolism, similar to that seen in hypoxic tissues. The exact mechanisms behind each of these theories and the extent to which they actively contribute to CM pathogenesis remain unresolved. However, both theories are consistent with evidence that the pathogenesis of CM results in significant alterations to cerebral metabolism.

Similar to the proposed CM cytokine theory, inflammation and a severe immunological cascade have been shown to act as critical mediators of ABM pathogenesis. It is generally accepted that the pathogenic bacteria responsible for ABM traverse from the blood into the ventricular or subarahnoid space, or gain direct access to the CNS through the olfactory bulb. Bacteria that have infiltrated the immune privileged CNS replicate and induce inflammation. The subsequent activation of CNS defences results in the recruitment of highly activated leukocytes from the blood into the CSF, propagating further inflammation. Progression of this immunological cascade results in necrotic and apoptotic neuronal damage/death within the hippocampus and cortex. Associated with this process is an accumulation of reactive oxygen species (ROS), which are capable of mediating oxidative damage to phospholipids, proteins, nucleic acids and nucleotides. Analysis of human CSF and serum from patients suffering ABM has shown increases in the concentration of metabolites (uric acid, allantoin and ascorbic acid) which are associated with ROS-mediated tissue damage.

CM and ABM victims may present with similar clinical symptoms and the two diseases share some degree of overlap between their pathogenic pathways. However, significant differences in the metabolites produced from the mechanisms driving abnormal glucose metabolism and oxidative damage may exist. Vibrational spectroscopy such as Fourier transform infrared (FTIR) spectroscopic analysis of serum may be used as a simple, rapid and chemical free means of diagnosing CM and ABM.

The mid-infrared region corresponds to the range of energies absorbed by the molecular vibrations of the major classes of biological molecules (lipids, carbohydrates, nucleic acids, organic phosphates, phospholipids, proteins, water and the metabolic products of these molecules). Hence, vibrational spectroscopic analysis of the mid-infrared region can provide considerable information regarding the concentration and structure of numerous biochemicals in a biological sample.

Advanced statistical techniques are required to convert the chemical information contained in infrared spectra to a value diagnostic of a disease state of the patient. The most common methods used include principal component analysis (RCA), partial least squares (PLS), K-means clustering (KMC) and linear discriminant analysis (LDA). Principal component analysis and partial least squares describe multivariate data using orthogonal functions derived from analysis of the variance in the data set. The independent functions (principal components) are linear combinations of the original data Therefore these techniques provide a powerful tool for identification and visualisation of trends within data sets. PCA is an unsupervised statistical analysis, assuming no prior knowledge of the origin of data, whereas PLS incorporates prior knowledge of the identity of samples in the training sets. Similarily, K-means cluster analysis (KMC) is an unsupervised classification method. KMC separates data into a predefined number of groups so as to minimise the within group variance and to maximise the between group variance.

It is thought that the use of principal component analysis serves to remove main differences in blood biochemistry that are associated with natural variations, rather than those differences specific to a particular disease. The removal of confounding biochemical information attributed to natural variation that dominates blood biochemistry is thought to facilitate the diagnostic capability of the described methods. The use of multi-variate analysis minimises confounding variations in the biological samples due to natural variations in such parameters that are not specific to the disease in question.

Alternatively a supervised classification method can be employed. Linear discriminant analysis calculates the statistical centre (centroid) of predefined groups within a data set. Based on statistical distance (measured by manhattan, Euclidean or mahalanobis distance), individual data points are assigned to the groups whose centroid they are nearest to.

In the examples described below, FTIR-spectroscopic analysis of dried films of serum, coupled to multivariate analysis techniques, has been employed to differentiate between mice having disease states that include bacterial meningitis, cerebral malaria, malaria anaemia and healthy controls. Currently there are no known chemical markers which can be detected in the blood to differentiate between these diseases. Further, the majority of patients (in regions where both meningitis and malaria occur) that are admitted to hospital with one of the above diseases may have both malaria parasites and bacteria present in their blood. Hence, positive detection of the pathogen in the blood does not of itself provide reliable diagnosis. This problem is likely to worsen with global warming and an increase in the natural range in which malaria occurs. Further, in developed countries, patients (in particular young children) do not always present with symptoms that warrant the use of a lumbar puncture.

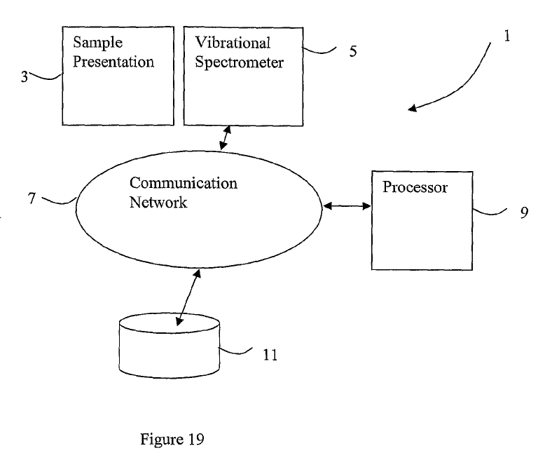

FIG. 19 illustrates a system 1 that may be used to develop a classifier for classifying biological samples. The system 1 includes one or more vibrational spectrometers 5. An example of such a spectrometer is the Bruker Tensor 27 FTIR HTS-XT spectrometer, which is fitted with a thermal glowbar infrared source and a mercury cadmium telluride detector. A sample presentation unit 3 may be associated with the spectrometer 5, for example to provide an automated way of presenting multiple biological samples to the spectrometer.

The spectrometer may have associated data processing capability. Alternatively, or in addition, the spectrometer 5 may have a data output enabling the transfer of data to one or more external processors, for example processor 9. The data may be transferred via a communication network 7, for example the Internet. Spectral data from a plurality of sites may be collected and stored in one or more databases 11.

The system 1 enables the collection of large collections of spectral data for use in the development of classifiers for diagnostic purposes. The data may be processed by statistical analysis software running on the processor 9 and/or the spectrometer 5 to develop the classifiers. Examples of such software are Opus Viewer 5.5 available from Bruker Optik and Unscrambler 9.6 software from Came, Norway.

Once the classifiers have been developed they may be widely distributed for application to spectra of biological samples of patients. The classifiers may, for example, be stored in a data storage of a spectrometer and applied to spectra for diagnosis. The classifiers may be stored with transportable units, for example for use in remote regions or in ambulances. The transportable units may include a portable power source to facilitate use in a travelling clinic.

In alternative arrangements the spectra obtained from the patient's biological samples are transferred via a communication network or physical storage device such as a DVD or flash memory device to a service unit where stored classifiers are applied to the spectra.

The computational device or processor 9 may be, for example, a microprocessor, microcontroller, programmable logic device or some other suitable device. Instructions and data to control operation of the computational device are stored in a memory, which is in data communication with, or forms part of, the computational device. Typically, the processor will include both volatile and non-volatile memory and more than one of each type of memory. The instructions to cause the processor to implement the present invention will be stored in the memory. The instructions and data for controlling operation of the processor 9 may be stored on a computer readable medium from which they are loaded into the processor memory. The instructions and data may be conveyed to the processor by means of a data signal in a transmission channel. Examples of such transmission channels include network connections, the Internet or an intranet and wireless communication channels.

In addition, the processor 9 may include a communications interface, for example a network card. The network card, may for example, send status information, or other information to a central controller, server or database and receive data or commands from the central controller, server or database. The network card and an I/O interface may be suitably implemented as a single machine communications interface.

The processor may have distributed hardware and software components that communicate with each other directly or through a network or other communication channel. The game controller may also be located in part or in its entirety remote from the associated user interface. Also, the processor may comprise a plurality of devices, which may be local or remote from each other. Instructions and data for controlling the operation of the user interface may be conveyed to the user interface by means of a data signal in a transmission channel.

The main components of the memory may include RAM that typically temporarily holds instructions and data related to the execution of the procedures and communication functions performed by the processor 9. An EPROM may provide a boot ROM device and/or may contain system code. A mass storage device may be used to store programs, including diagnostic classifiers, the integrity of which may be verified and/or authenticated by the processor using protected code from the EPROM or elsewhere.

It will be appreciated that the classifier algorithms may also be implemented in other types of processors including digital signal processors (DSPs), application-specific integrated circuits (ASICs) and field-programmable gate arrays (FPGAs).

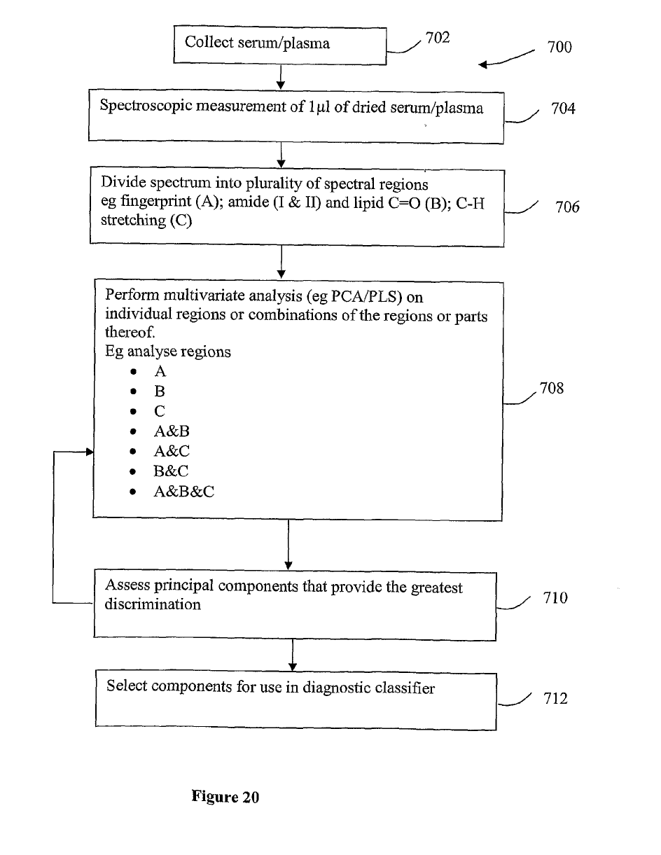

FIG. 20 illustrates a method 700 of developing a multivariate classifier.

In step 702 blood samples are collected, and in step 704 spectroscopic measurements are obtained of dried serum or plasma from the samples. In step 706 the spectra are divided into spectral regions, for example (A) fingerprint<1490 (cm⁻¹); (B) amide (I & II) and lipid C═O (1490-1800 cm⁻¹) and (C) CH Stretching (2800-3100 cm⁻¹).

In steps 708 and 710 an iterative analysis procedure is followed. Multivariate analysis (for example PCA/PLS) or other chemometrics technique is performed using either individual regions or a combination of the regions or parts thereof. For example, analyses may be performed on each of the three regions (A, B and C) separately, then the analysis is repeated using a combination of A&B, A&C, B&C and A&B&C.

The principal components that provide the greatest discrimination are identified in step 710 and may be selected in step 712 for use as a diagnostic classifier. An aim of the iterative analysis steps 708, 710 is to separate out markers in the spectrum of the plasma or serum sample that are due to natural variations (including genetic factors, sex, food consumption and hormonal cycles) and identify those underlying spectral markers that provide disease-specific information that leads to reliable diagnostic tests.

This iterative methodology 700 is repeated for the development of each diagnostic method, to identify the principal components that provide the optimal separation for the diseases being studied. Once the principal components are identified (these may differ for different diagnostic methods) they are used for all future diagnosis. Algorithms may run as software, for example on a processor 9 or using a processing capability of the spectrometer 5 to apply the diagnostic classifier to spectra collected from new patients. A “score” Is calculated for the appropriate principal components and a diagnosis achieved using the classifier previously developed by method 700.

A hierarchical approach may also be used when there are numerous potential disease states to be differentiated. For example, to provide a diagnosis from five possible diseases (disease A-E), a score may be generated for a patient's spectrum using one particular diagnostic method whose principal components discriminate between diseases A-B and C-E. For example the score generated may diagnose the patient as having either disease A or B, but not diseases C-E.

A second score for that patient's spectrum may then be generated using a second diagnostic method, which might include a second region or combination of regions. These principal components provide separation between disease A & B. This can be incorporated into a neural network that requires no user intervention.

### EXAMPLE 1

Animal Models

Mice (female, C57/B6) were infected at an age of 6 weeks.

Cerebral Malaria

Infection of 21 mice was performed via an intraperitoneal injection of 200 μL of blood containing the malarial parasite P. berghei ANKA (PBA) at a PRBC count of approximately 1×10⁶.

Mild & Severe Non-Cerebral Malarial Anaemia

Infection of 28 mice in the case of severe malaria and 20 mice in the case of mild malaria was performed via an intraperitoneal injection of 200 μL of blood containing the malarial parasite P. berghei K173 (PBK) at a PRBC count of approximately 1×10⁶.

Bacterial Meningitis

Infection of 19 mice was performed via intercranial Injection of S. pneumoniae in 10 μL of PBS, at a bacteria count of 3.8×10⁷ colony forming units (CFU).

Malaria Controls

29 mice were injected with 200 μL of PBS.

Bacterial Meningitis Controls

19 mice were injected with 10 μL of PBS solution via an intercranial injection.

Bacterial Meningitis Time Course Studies

Infection of 6 mice was performed via intercranial injection of S. pneumoniae in 10 μL of PBS, at a bacteria count of 3.8×10⁷ colony forming units (CFU). Five control mice were injected with 10 μL of PBS solution via an intercranial injection. Venous blood was collected from the tail of mice before inoculation (0 hours) and at 16, 28 and 40 hours after inoculation.

Blood Collection

Blood was collected on the following days post infection; day 6 for PBA infected mice (CM), day 6 for 13 of the PBK infected mice (M), day 14 for the remaining 13 PBK infected mice (SM), day 2 for S. pneumoniae infected mice (ABM), day 6 for malaria controls, day 2 for bacterial meningitis controls.

Mice were anaesthetised by inhalation of isofluorine vapours, then 500 μL of blood was collected via retro orbital bleeding. Immediately following blood collection, the parasite count was recorded from a thin blood smear. The remaining blood was allowed to clot at room temperature (−22° C.) for a period of 1 hour, before serum was separated via centrifugation at 1500 rpm for 10 minutes. Serum was stored at −20° C. prior to infrared spectroscopic analyses.

Infrared Spectroscopic Analyses of Dried Serum Films

Stored serum samples were thawed at room temperature (−22° C.) prior to analysis. A 1 μL aliquot of each sample was transferred onto an infrared transparent silicon microtitre plate (each sample was analysed in triplicate). Each sample was allowed to air dry for a period of 30 minutes, to produce a dried film.

Infrared analyses were performed using a Bruker Tensor 27 FTIR HTS-XT spectrometer, fitted with a thermal glowbar infrared source and a mercury cadmium telluride detector. Spectra were collected over the range 400-4000 cm⁻¹ at a resolution of 4 cm⁻¹, with the co-addition of 64 scans per spectrum. A background spectrum was taken before each sample measurement.

Data Analysis

Data analysis was performed using Opus Viewer 5.5 (Bruker Optik, 1997) and Unscrambler 9.6 (Unscrambler, 1986) software. All spectra were scaled via vector normalisation across selected regions. In one approach the selected regions were 500-1800 cm⁻¹ and 2800-3100 cm⁻¹. Second derivative spectra were calculated using a 13 point Savitsky-Golay filter. For principal component analysis, 7 data groups were developed for the comparison of spectral variance with disease state (see Table 1A). Principal component analysis (PCA) was performed on the scaled, second derivative spectra across the following regions; fingerprint region (550-1490 cm⁻¹⁾ and lipid carbonyl region, also referred to as the C═O stretching region (1700-1760 cm⁻¹), amide I and amide II region (1490-1700 cm⁻¹) and the lipid region, also referred to as the C-H stretching region (2820-3050 cm⁻¹). The boundary points of these regions may vary to some extent. For example, in different analyses a boundary of the lipid region may be taken as 3100, 3050 or 3040 cm⁻¹, and a boundary of the fingerprint region may be taken as 550, 580 or 700 cm⁻¹.

The C═O stretching region and the amide region are adjacent and, in the following discussion, may be referred to a single region.

A 2-group KMC using the calculated manhattan distances between the principal component scores was employed for classification.

TABLE 1A
Data Groups for PCA

| | |
|---|---|
| Group 1 | Bacterial Meningitis vs Cerebral |
| | Malaria |
| Group 2 | Bacterial Meningitis vs Severe |
| | Malaria Anaemia |
| Group 3 | Bacterial Meningitis vs Mild Malaria |
| | Anaemia |
| Group 4 | Bacterial Meningitis vs Healthy |
| | Controls |
| Group 5 | Cerebral Malaria vs Severe Malaria |
| | Anaemia |
| Group 6 | Cerebral Malaria vs Mild Malaria |
| | Anaemia |
| Group 7 | Cerebral Malaria vs Healthy Controls |

In another, hierarchical, data analysis method, the measured spectra were scaled via vector normalisation across the regions 700-1490cm⁻¹, 1490-1800 cm⁻¹ and 2800-3100 cm⁻¹. Second derivative spectra were calculated using a 9 point Savitsky-Golay filter. The use of derivatives helps to remove baseline and background effects. Normalising spectra serves to remove or limit differences arising from sample preparation.

Partial least squares analysts was carried out using a two-step hierarchical approach. The first step involved PLS analysis across the region 2800-3100 cm⁻¹ to separate healthy mice and mice suffering mild malaria from mice suffering cerebral malaria, severe malaria or bacterial meningitis. This separation was achieved using the first two PLS components. The second step involved two PLS analyses on the fingerprint region 700-1490 cm⁻¹ and amide I, amide II and C═O stretching regions 1490-1800 cm⁻¹. Separation between mice suffering cerebral malaria, severe malaria and bacterial meningitis was achieved using the first PLS component from each of the two PLS analyses. The y-variables used in the hierarchical PLS analyses are shown in Table 1B.

TABLE 1B
Data Groups for PLS hierarchical analysis

| Data Set | Step 1 | Step 2(i) | Step 2 (ii) |
|---|---|---|---|
| Healthy | 0 | — | — |
| Mild Malaria | 0 | — | — |
| Severe Malaria | 1 | 1 | 0 |
| Cerebral Malaria | 1 | 0 | 0 |
| Bacterial Meningitis | 1 | 0 | 1 |

The diagnostic prediction values, sensitivity and specificity values were calculated as follows:

DPV=(N_{C}/N_{T})×100 (Equation 1)

where DPV=diagnostic prediction value; Nc=number of spectra correctly classified; and N_{T}=total number of spectra.

Sensitivity=N_{CA}/(N_{CA}+N_{IB}) (Equation 2)

where N_{CA}=number of correctly classified spectra for disease A and N_{IB}=number of incorrectly classified spectra for disease B.

Specificity=N_{CB}/(N_{CB}+N_{IA}) (Equation 3)

where N_{CB}=number of correctly classified spectra for disease B and N_{IA}=number of incorrectly classified spectra for disease A.

It is proposed that the multivariate statistical analysis serves to reduce confounding information, for example from genetic differences between patients, blood sugar, etc. due to normal cycles and the consumption of food. The classifying algorithms developed through the multivariate analysis reveal underlying chemical information that distinguishes one disease from another. The statistical analysis typically captures most of the masking natural variability in the first principal component (PC1). In this case the classifying algorithm may ignore this information to focus on more subtle underlying information that is disease specific.

Results

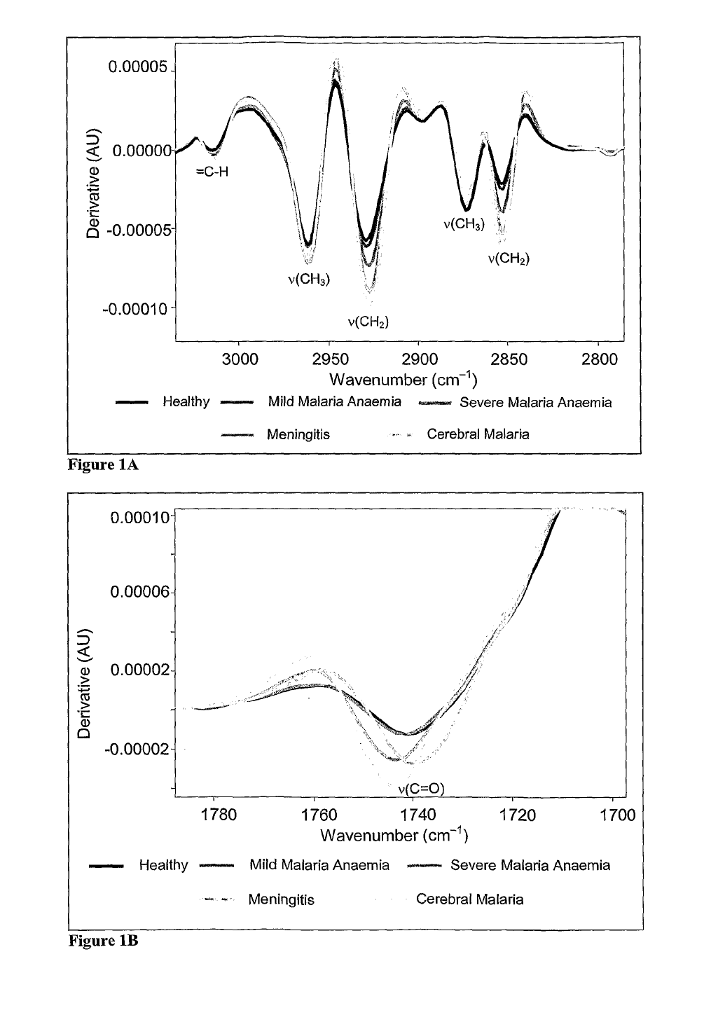

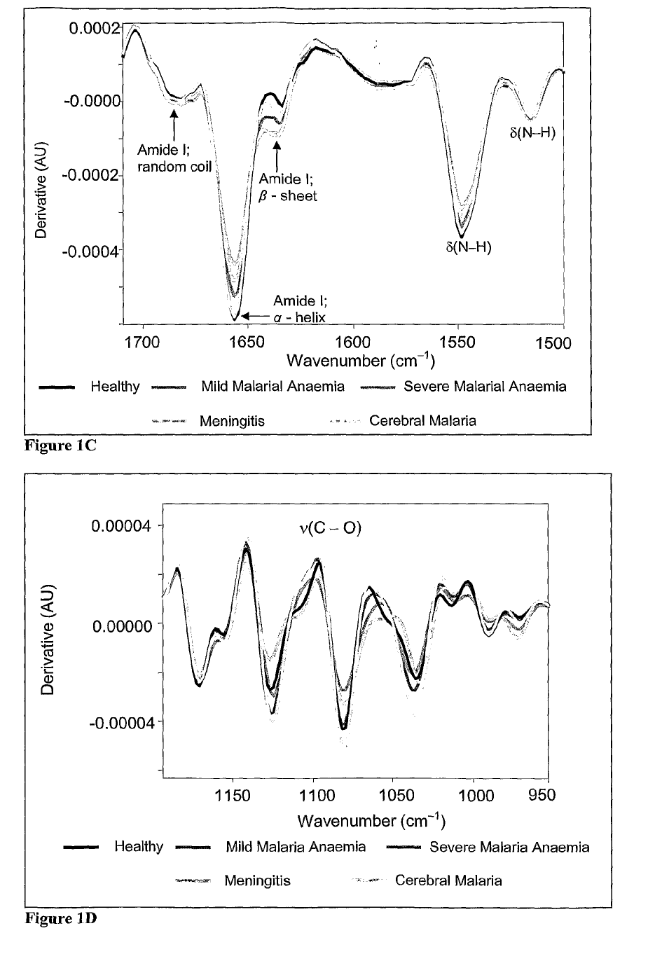

This example demonstrates the use of infrared spectroscopy to differentiate between serum collected from mice suffering cerebral malaria, bacterial meningitis and malaria anaemia. Examples of the average second derivative mid-infrared spectra collected from the serum of mice suffering each of these disease types (as well as healthy controls) are presented in FIGS. 1A-1D. The major molecular vibrations that give rise to characteristic peaks in the spectra also have been highlighted.

The average spectra presented in FIG. 1A show the C—H stretching vibrations of lipids present in serum in the region 3050-2800 cm⁻¹. It can be seen that mice suffering severe malaria anaemia, cerebral malaria and meningitis display a significantly increased intensity across all peaks corresponding to C—H stretching vibrations. These results suggest a significant increase in the lipid content (particularly oxidised lipids) of serum at the near death stage for mice suffering severe malaria anaemia, cerebral malaria and meningitis.

FIG. 1B shows average second derivative spectra (C═O stretching region of lipids, 1760-1700 cm⁻¹) of dried serum collected from the mice. The average second derivative spectra presented in FIG. 1B complement the trend shown in FIG. 1A. Mice suffering severe malaria anaemia, cerebral malaria and meningitis all display a significant increase in the intensity of the C═O stretching peak. Again, this highlights an increase in the lipid content during the late stages of the above-mentioned diseases. In addition, the C═O peak is shifted to a higher wavenumber in mice suffering severe malaria anaemia and cerebral malaria. However, the C═O peak is shifted to a lower wavenumber in mice suffering meningitis. These peak shifts suggest the presence of oxidised lipids in the serum of diseased mice. Further, the opposing direction of the peak shifts suggest that different oxidative mechanisms operate in meningitis compared to cerebral malaria and severe malaria anaemia.

FIG. 1C shows average second derivative spectra in the amide I & II region of proteins, 1700-1500 cm⁻¹. The amide I and amide II region show differences in the protein content of the serum samples. Further, the amide I band is thought to differentiate between the secondary structure of proteins. In general, the peak centred at 1680 cm⁻¹ corresponds to proteins with a random structure, the peak centred at 1655 cm⁻¹ corresponds to proteins with an α-helix structure and the peak centred at 1635 cm⁻¹ corresponds to proteins with a β-sheet sheet structure. The spectra in FIG. 1C show significant increase in proteins of β-sheet structure in mice suffering severe malaria anaemia and meningitis. This increase occurs with a corresponding decrease in proteins of α-helix structure. However, serum from mice suffering cerebral malaria show α-helix and β-sheet protein contents similar to those of healthy mice.

FIG. 1D show average second derivative spectra in the fingerprint region, C—O of carbohydrates, nucleic acids and lipids, 1200-950 cm⁻¹. The spectra presented in FIG. 1D show numerous peaks that result from the variety of C—O stretching vibrations of carbohydrates, lipids and nucleic acids. As has been seen in FIGS. 1A-1C, there are significant differences in the average spectra for each disease presented in FIG. 1D. The average spectra for serum from mice suffering bacterial meningitis shows decreased intensity across peaks centred at 1125, 1080, 1010 and 990 cm⁻¹, but increased intensity across peaks centred at 1110 and 970 cm⁻¹. Further, the peak centred at 1040 cm⁻¹ for the spectra of all other mice is shifted to 1035 cm⁻¹ in the spectra of serum corresponding to mice suffering bacterial meningitis. The spectra corresponding to the serum of mice suffering cerebral malaria show increased intensity across peaks centred at 1125, 1080 and 1040 cm⁻¹, but decreased intensity across the peak centred at 1110 cm⁻¹. The spectra corresponding to serum of mice suffering severe malaria anaemia display increased peak intensity across the peak centred at 970 cm⁻¹, but decreased intensity across the peaks centred at 1110, 1080 and 1010 cm⁻¹. These differences are a strong suggestion for altered mechanisms of glucose metabolism between mice suffering bacterial meningitis, cerebral malaria and severe malaria anaemia,

It can be seen from FIGS. 1A-1D that differences in the biochemical composition of serum (as a result of disease) manifest as variance in the peak intensities and peak positions in the second derivative infrared spectra. In addition to visual analysis of the spectra, the variance between spectra collected from the serum of animals suffering various diseases has been analysed using multivariate analysis (PCA and PLS).

As mentioned above, PCA and PLS analyses were applied to three individual regions of the infrared spectra. These regions correspond to the C—H stretching region 2800-3100 cm⁻¹ (infrared absorbance due to C—H stretching vibrations of lipids), the ester carbonyl, amide I and amide II region 1800-1490 cm⁻¹ (infrared absorbance due to vibrations of the amide linkage in proteins) and the fingerprint region 1490-700 cm⁻¹ (many contributions to infrared absorbance from carbohydrates, lipids, proteins and nucleic acids). The principal components identified act as a pattern recognition technique, identifying spectral regions which account for a certain percentage of the observed variance. As such, principal components (which account for the greatest variance between different disease states) were selected for each of the 3 regions studied.

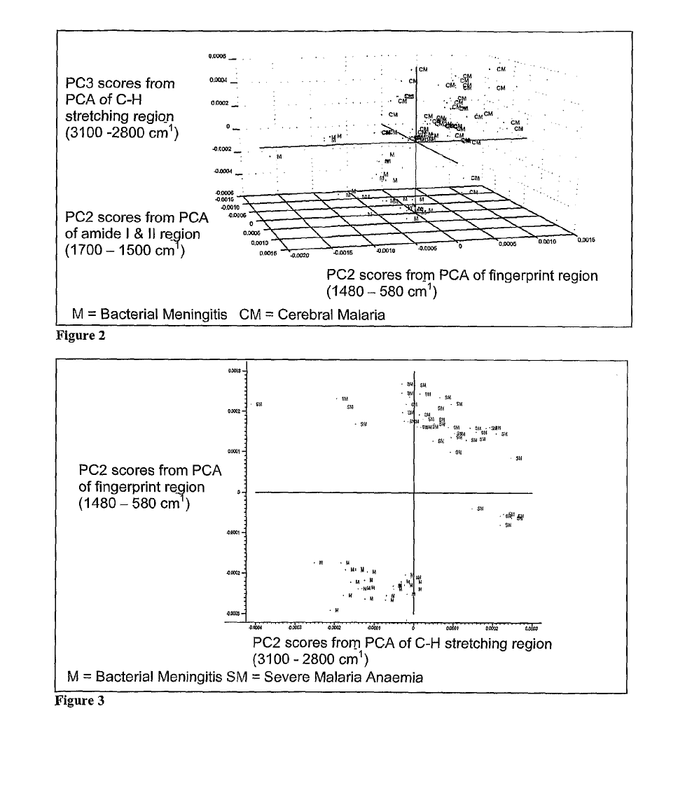

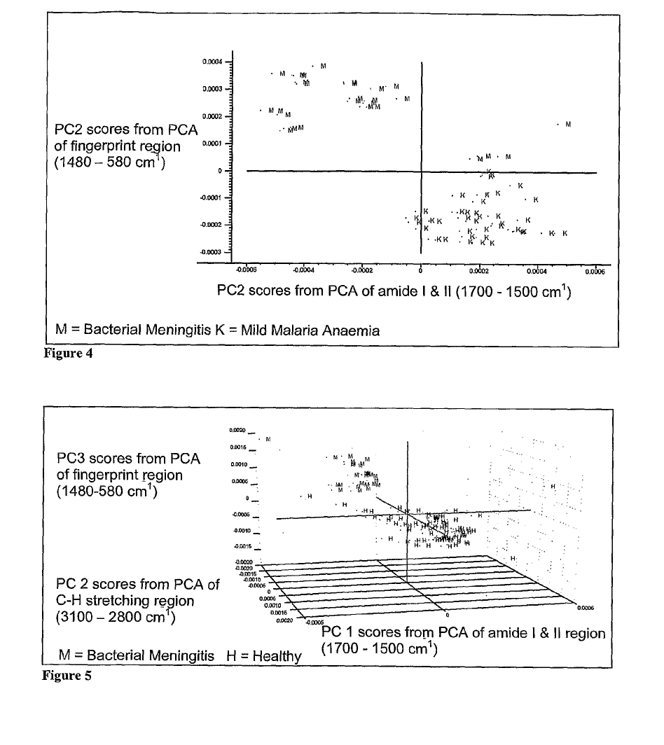

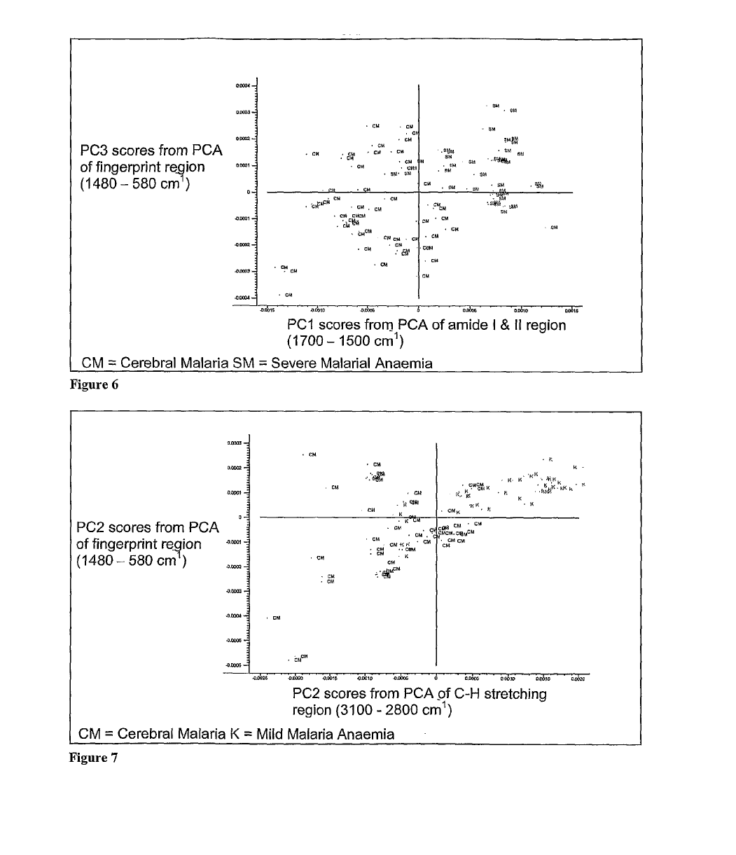

Examples of plots of the principal component scores (either as a 2D plot for comparison of 2 spectral regions or as a 3D plot for comparison of three spectral regions) are presented in FIGS. 2-8A. The score plots provide a visual representation of the difference in variance between the infrared spectra that correspond to different types of disease.

The scores plots presented in FIGS. 2-8 separate the spectra of serum based on the type of disease the mouse was suffering. A definitive and objective assignment of a single spectrum to a specific disease may be achieved by performing K-means cluster analysis (KMC) on the principal component scores (for each of the 3 principal components plotted). KMC analysis separates the data set into a certain predefined number of groups, so as to minimise the within-group variance and maximise the between-group variance. KMC is an unsupervised classification method, assuming no prior knowledge of the sample identity. A two-group KMC analysis was performed for each set of data (principal component scores) presented in FIGS. 2-8. The objective was to use KMC to classify spectra as belonging to a certain disease (ie for a two-group KMC, spectra classified as group one correspond to one type of disease and spectra classified as group two correspond to a separate disease). For a two-group KMC, successful discrimination between two diseases occurs only if the spectral variance separating the two diseases is the largest source of variance in the data set. The results from the KMC analysis along with the calculated diagnostic prediction values, sensitivities and specificities for an experimental data set are presented in Tables 2-8.

TABLE 2
Diagnosis of Bacterial Meningitis and Cerebral Malaria

| | Bacterial | Cerebral |
|---|---|---|
| Known | Meningitis | Malaria |
| Disease Type | (KMC Predicted) | (KMC Predicted) |
| Bacterial | 27 | 0 |
| Meningitis | | |
| (27) | | |
| Cerebral | 1 | 53 |
| Malaria (54) | | |

Positive Diagnostic Prediction Value = 100%
Negative Diagnostic Prediction Value = 98%
Sensitivity = 96%
Specificity = 100%

TABLE 3
Diagnosis of Bacterial Meningitis and Severe Malaria Anaemia

| | | Cerebral |
|---|---|---|
| | Bacterial | Severe Malaria |
| Known | Meningitis | Anaemia |
| Disease Type | (KMC Predicted) | (KMC Predicted) |
| Bacterial | 27 | 0 |
| Meningitis | | |
| (27) | | |
| Severe | 0 | 42 |
| Malaria | | |
| Anaemia (42) | | |

Positive Diagnostic Prediction Value = 100%
Negative Diagnostic Prediction Value = 100%
Sensitivity = 100%
Specificity = 100%

TABLE 4
Diagnosis of Bacterial Meningitis and Mild Malaria Anaemia

| | Bacterial | Mild Malaria |
|---|---|---|
| Known | Meningitis | Anaemia |
| Disease Type | (KMC Predicted) | (KMC Predicted) |
| Bacterial | 23 | 4 |
| Meningitis | | |
| (27) | | |
| Mild Malaria | 0 | 39 |
| Anaemia (39) | | |

Positive Diagnostic Prediction Value = 85%
Negative Diagnostic Prediction Value = 100%
Sensitivity = 100%
Specificity = 91%

TABLE 5
Diagnosis of Bacterial Meningitis and Healthy Controls

| | Bacterial | Healthy |
|---|---|---|
| Known | Meningitis | Controls |
| Disease Type | (KMC Predicted) | (KMC Predicted) |
| Bacterial | 22 | 5 |
| Meningitis | | |
| (27) | | |
| Healthy | 4 | 65 |
| Controls (69) | | |

Positive Diagnostic Prediction Value = 100%
Negative Diagnostic Prediction Value = 98%
Sensitivity = 100%
Specificity = 96%

TABLE 6
Cerebral Malaria and Severe Malaria Anaemia

| | Cerebral | Severe Malaria |
|---|---|---|
| Known | Malaria | Anaemia |
| Disease Type | (KMC Predicted) | (KMC Predicted) |
| Cerebral | 51 | 3 |
| Malaria (54) | | |
| Severe | 3 | 39 |
| Malarial | | |
| Anaemia (42) | | |

Positive Diagnostic Prediction Value = 94%
Negative Diagnostic Prediction Value = 93%
Sensitivity = 94%
Specificity = 93%

TABLE 7
Diagnosis of Cerebral Malaria and Mild Malaria Anaemia

| | Cerebral | Mild Malaria |
|---|---|---|
| Known | Malaria | Anaemia |
| Disease Type | (KMC Predicted) | (KMC Predicted) |
| Cerebral | 44 | 10 |
| Malaria (54) | | |
| Mild Malaria | 7 | 32 |
| Anaemia (39) | | |

Positive Diagnostic Prediction Value = 81%
Negative Diagnostic Prediction Value = 82%
Sensitivity = 86%
Specificity = 76%

TABLE 8
Diagnosis of Cerebral Malaria and Healthy Controls

| | Cerebral | Healthy |
|---|---|---|
| Known | Malaria | Controls |
| Disease Type | (KMC Predicted) | (KMC Predicted) |
| Cerebral | 54 | 0 |
| Malaria (54) | | |
| Healthy | 10 | 59 |
| Controls (69) | | |

Positive Diagnostic Prediction Value = 100%
Negative Diagnostic Prediction Value = 86%
Sensitivity = 84%
Specificity = 100%

As can be seen from Tables 2-8, differentiation between the various diseases is achieved with high diagnostic prediction values, high sensitivity values and high selectivity values.

As can be seen from FIGS. 2-8 and Tables 2-8, infrared spectroscopic analysis of dried films of serum coupled to principal component analysis and unsupervised classification is a sensitive and specific method for discrimination between mice suffering bacterial meningitis, cerebral malaria and malarial anaemia.

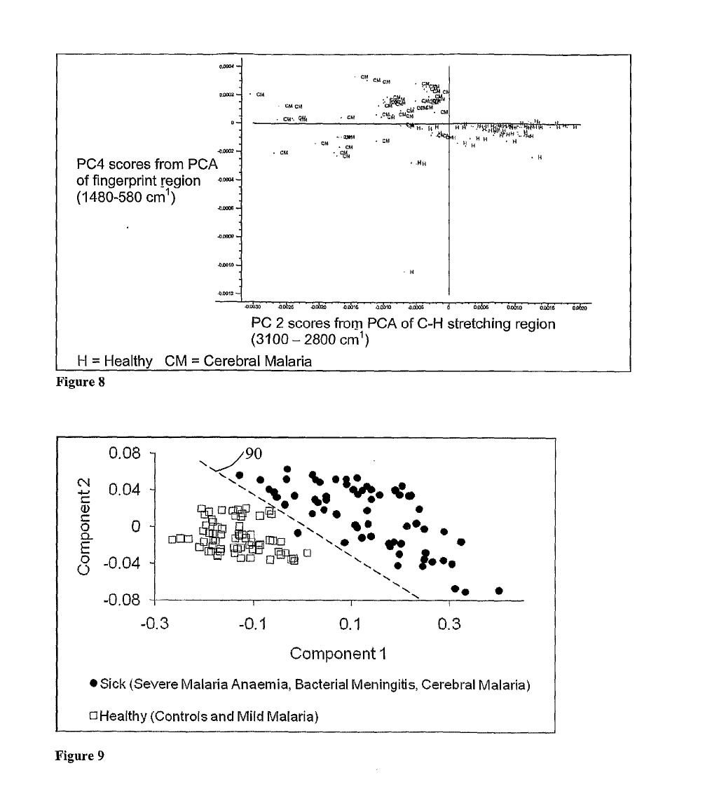

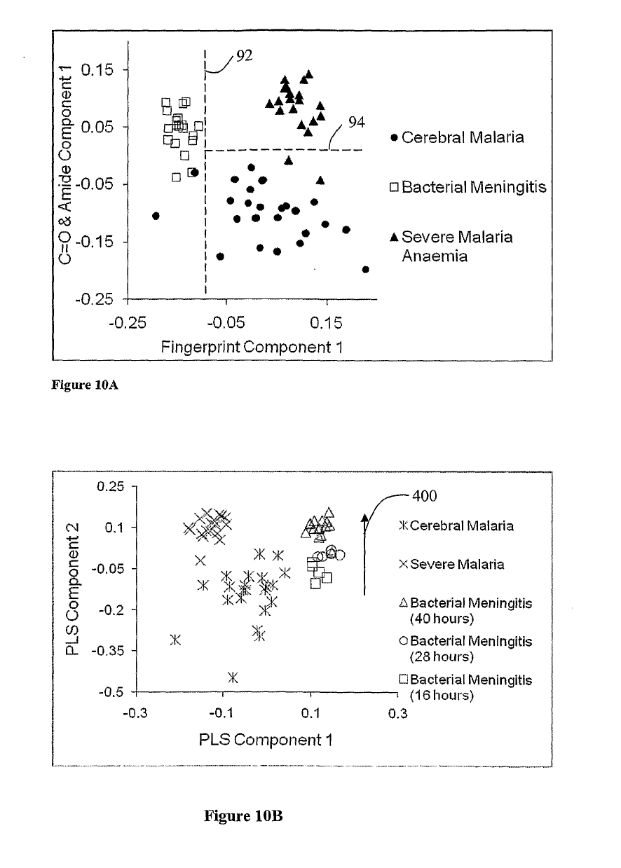

FIG. 9 shows an example of results from the first step of the hierarchical partial least squares (PLS) regression analysis, based on the CH stretching region (2800-3040 cm⁻¹) of FTIR spectra collected from dried mouse serum. The data set includes mice with Severe Malaria (N=21), Bacterial Meningitis (N=19), Cerebral Malaria (N=26), Controls (N=48), Mild Malaria (N=20). As illustrated by line 90, a linear classification may be derived from the PLS analysis to separate the spectra of sick and healthy mice. The spectra of the sick mice, as determined by the first step of the PLS analysis, are further processed in the following stage of the PLS analysis to discriminate between individual diseases.

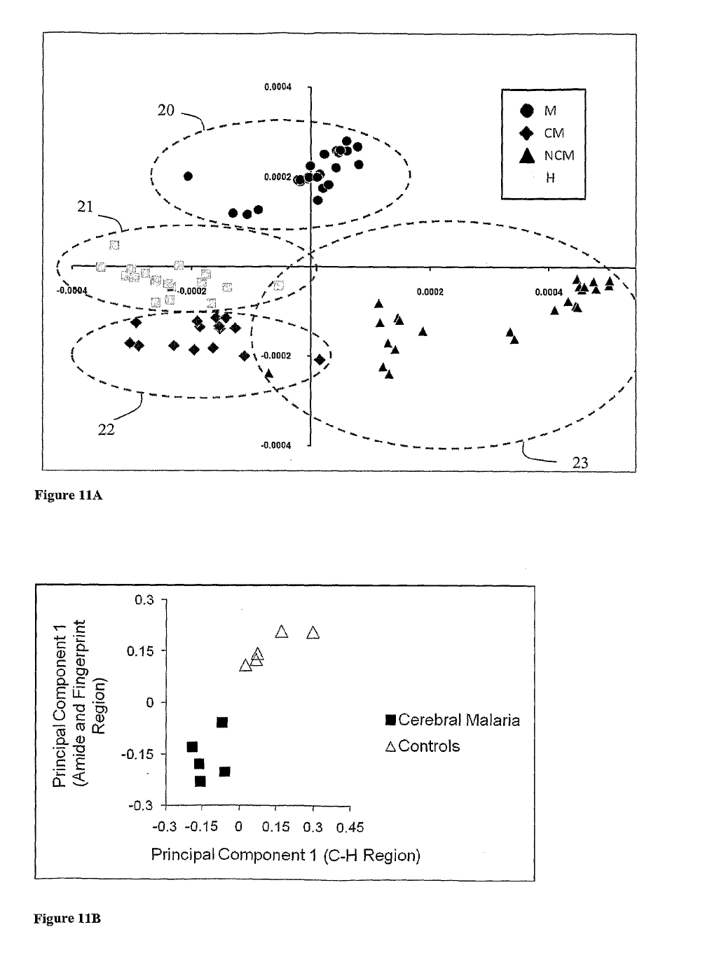

FIG. 10A shows an example of results from the second step of the hierarchical PLS regression analysis, based on the fingerprint region (700-1490 cm⁻¹) and the C═O and amide region (1490-1800 cm⁻¹), of FTIR spectra collected from dried mouse serum. The data set includes mice with Severe Malaria (N=21), Bacterial Meningitis (N=19), and Cerebral Malaria (N=25). As illustrated In the FIG. 10, the analysis provides a first linear classifier 92 that distinguishes between bacterial meningitis and the two malarial diseases. The analysis also provides a second linear classifier 94 that distinguishes between cerebral malaria and severe malaria anaemia.

FIG. 10B shows an example of a third classification step that refines the classification of FIG. 10B. The third classification indicates both a progression of meningitis and a diagnosis of CM, SM and ABM. The classification is based on PLS analysis on fingerprint, amide and C═O spectral region (800-1800 cm⁻¹). The data points separate into three groups, dependent on whether the mouse had cerebral malaria, severe malaria or bacterial meningitis. In addition to the separation between diseases, the scores provide a means of assessing and tracking the progress of the meningitis. The meningitis results are indicated by open squares (representing blood samples taken 16 hours after inoculation), open circles (representing blood samples taken after 28 hours) and open triangles (representing blood samples taken after 40 hours). The meningitis results fall into a generally linear progression, indicated by the arrow 400. The arrow thus highlights the trend of increasing sickness of meningitis mice.

There is one overlap in the linear progression indicated by arrow 400. One 40-hour data point overlaps with data points taken at 28 hours. The terminal stage of meningitis occurs at 40 hours post infection. However, a clinical examination of the mouse whose 40 hour data overlapped the 28-hour data indicated that the 40-hour mouse was at an earlier stage in the disease than the remaining mice at the 40 hour time point. Accordingly, the progression 400 is indicative of the progression of the meningitis.

Based on the PLS scores presented in FIGS. 9 and 10, PLS regression obtained the following diagnostic values for the diagnosis of severe malaria anaemia, cerebral malaria and bacterial meningitis (Table 9).

TABLE 9
Diagnosis of Bacterial Meningitis, Cerebral
Malaria arid Severe Malaria Anaemia

| | Positive | Negative | Sensitivity | Specificity |
|---|---|---|---|---|
| Disease | Prediction % | Prediction % | % | % |
| Bacterial | 100 | 100 | 100 | 100 |
| Meningitis | | | | |
| Cerebral | 96 | 99.1 | 96.1 | 100 |
| Malaria | | | | |
| Severe Malaria | 95.2 | 100 | 100 | 96.1 |
| Anaemia | | | | |
| Healthy | 100 | 98.6 | 98.5 | 100 |
| (Controls & | | | | |
| Mild Anaemia) | | | | |

Once a classification algorithm has been developed based on a training data set, the classification algorithm may be applied to the diagnosis of previously unseen spectra. For example, blood may be obtained from a mouse having an unknown health status. The FTIR spectrum of serum is measured, including the regions used in the classification algorithm. The spectrum is then analysed using the previously defined classification algorithm (for example the 2-stage PLS analysis illustrated above) to determine whether the mouse is healthy or sick and, if so, if it is likely to be suffering one of the diseases that are the subject of the classification.

FIG. 11A shows an example of a two-dimensional plot having four classified regions based on the infrared profiles of mice with different pathologies. This classification is based on a non-hierarchical analysis using PCA. Classified region 20 encompasses the spectra of mice with meningitis (denoted M). Classified region 21 encompasses the spectra of healthy mice (H). Classified region 22 encompasses the spectra of mice with cerebral malaria (CM). Classified region 23 encompasses the spectra of mice with non-cerebral malaria (NCM). There is a relatively small overlap between regions 21 and 23 and between regions 22 and 23. Nevertheless, the classification provides a clear distinction between the infrared profiles.

The described embodiment uses unsupervised classification, which is generally less sensitive, less specific and less robust than supervised classification methods (such as linear discriminant analysis). However, for exploratory investigations, unsupervised classification may identify the nature and extent of variance between individual data sets. The example shows (through the use of a 2-group unsupervised classification) that the largest source of variance between the data for two disease types occurs as a direct consequence of the disease types. It will be understood that supervised classification methods may also be applied.

The methods described herein provide a rapid diagnostic method for accurate discrimination between acute clinical conditions that have similar clinical symptoms but require different and timely clinical interventions. The methods may help to minimise the time between hospitalisation and initialisation of appropriate therapies, reducing the morbidity and mortality of the diseases. Further, the diagnostic method for meningitis is expected to be of great medical and economical value.

The described example uses FTIR spectroscopy. The training and diagnostic methods may also use other types of vibrational spectroscopy such as Raman spectroscopy. The example analyses the spectra of serum. In other arrangements different biological samples may be used, for example blood, plasma, urine and cerebrospinal fluid.

FIG. 11B shows an example of Raman spectroscopic analysis of dried films of mouse serum, distinguishing between cerebral malaria and a control group. The PLS component scores were obtained from PLS analysis on the C—H stretching region between 2800-3100 cm⁻¹ and the amide and fingerprint region, between 800-1800 cm⁻¹. The data set includes five mice with cerebral malaria and 5 controls. The first principal component scores from the C—H region is plotted against the first principal component scores from the, amide and fingerprint region. The plotted data pairs show a separation between the controls and the mice with cerebral malaria.

Other multivariate statistical analysis techniques may be used to analyse the spectra. For, example neural networks may be used to develop the classifier.

The described arrangements may also be used to distinguish between other groups of disease states that present with clinically similar symptoms, ie disease states that are substantially indistinguishable clinically. For example, it is difficult to distinguish clinically between viral and bacterial meningitis. However, the mechanisms by which viruses and bacteria cause meningitis are different and consequently a classifier may be developed to distinguish between the diseases based on their spectroscopic signatures.

### EXAMPLE 2

### Time Course Study of Bacterial Meningitis

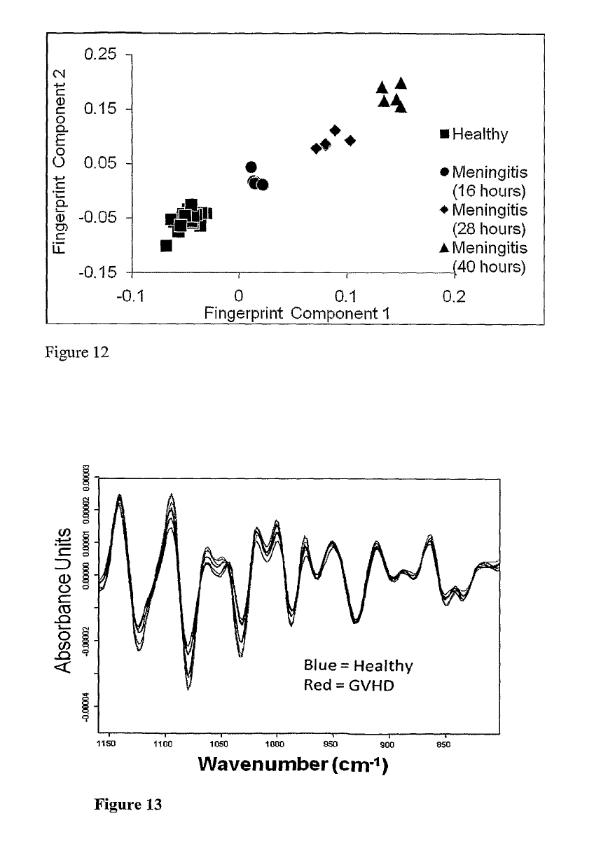

PLS analyses were also performed on serum samples collected as a time course over the duration of the development of acute bacterial meningitis. The results, illustrated in FIG. 12, show that principal components can be identified that highlight a strong correlation between spectra and disease development. The first principal component scares from PLS analyses on the regions 1800-1490 and 1490-700 cm⁻¹ of spectra collected from the serum obtained from mice at 0, 16, 28 and 40 hours post inoculation with mice at S. pneumonia are shown in FIG. 12. The results show a strong correlation exists between the principal component scores and the development of acute bacterial meningitis.

A classifier may be trained that uses FTIR spectroscopy of biological fluids to identify the stage in disease progression as well as to differentiate between different disease types. The spectral changes are seen earlier than the clinical changes became apparent in the experiment.

In FIG. 12, the samples indicated as healthy include serum collected from mice (N=5) at 0 hours (prior to infection) as well as serum collected from control mice injected with PBS (N=5).

The methods may provide a useful tool, for instance, for rapid testing of populations (such as a school) where a student has meningitis and localised populations where there is a meningitis outbreak. The input sample involves a simple blood test. Once it is established which students had contracted the disease they can be quarantined from other students and monitored for their treatment. In developing countries, the cost of drugs for treating larger populations who do not need them can be prohibitive so it is useful to determine who needs treatment before the disease takes hold.

For the meningitis mouse models, the classification achieved diagnosis at 16 hours, that is 1 day before clinical diagnosis of the disease (which typically is only a 2-3 day disease).

### EXAMPLE 3

### Diagnosis of Graft-Versus-Host Disease (GVHD)

FTIR spectroscopy combined, with multivariate statistical analysis has been used to indicate the onset of GVHD before clinical symptoms of the disease are evident. Thus, the methods may distinguish between the disease states of “healthy” or, “GVHD” even though there are no clinical symptoms to distinguish between these disease states at the time of testing.

A sample set of data was collected over 3 months. 11 patients were tracked for about 5 weeks each following a bone marrow transplant (BMT). The analysis of these data revealed spectral signatures that differentiate between patients that had a successful transplant and those that went on to develop GVHD (3 out of the 11). Specifically, the spectra appear to indicate changes in lipid oxidation and carbohydrate metabolism in the patients who developed GVHD.

The early separation of the patients' blood chemistry was discernable before there was any clinical evidence of GVHD. As the patients progressed to show outward symptoms of GVHD, the separation of their blood chemistry from that of the “healthy” patients increased. The potential of this is that not only could the patient be diagnosed before the disease was evident through previously used diagnostic procedures, but the analysis may reveal what stage the disease has reached. This may provide a useful tool for optimal early intervention.

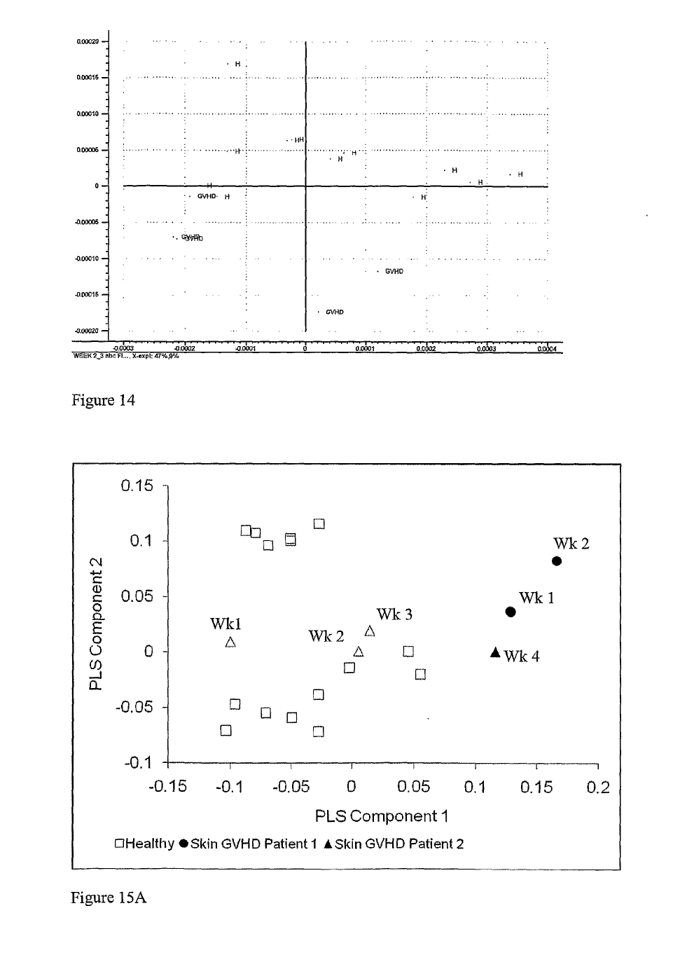

In the data shown in FIGS. 13 and 14, blood samples were collected from three patients three weeks after the patients had undergone a bone marrow transplant. Two of the patients were subsequently discharged from hospital in week 5 after the operation, having successfully recovered. The third patient was admitted to ICU in week 5 with GVHD. FIG. 13 shows spectra, collected in triplicate for each sample, of the patients. The spectra are plotted in the range 1150-800 cm⁻¹, which reflects C—O bonds of carbohydrates, nucleic acids, fatty acids, and organic phosphates.

FIG. 14 shows the PCA scores (PC1 v PC3) of a non-hierarchical classification derived from the spectra in an initial data set. The sample points deriving from the patients who recovered are marked “H” and the sample points from the patient who later died are marked “GVHD”. The plot shows a clear differentiation between the two groups. Consequently a classifier may be applied to infrared spectra obtained from patients following a bone marrow transplant in order to diagnose the onset of GVHD.

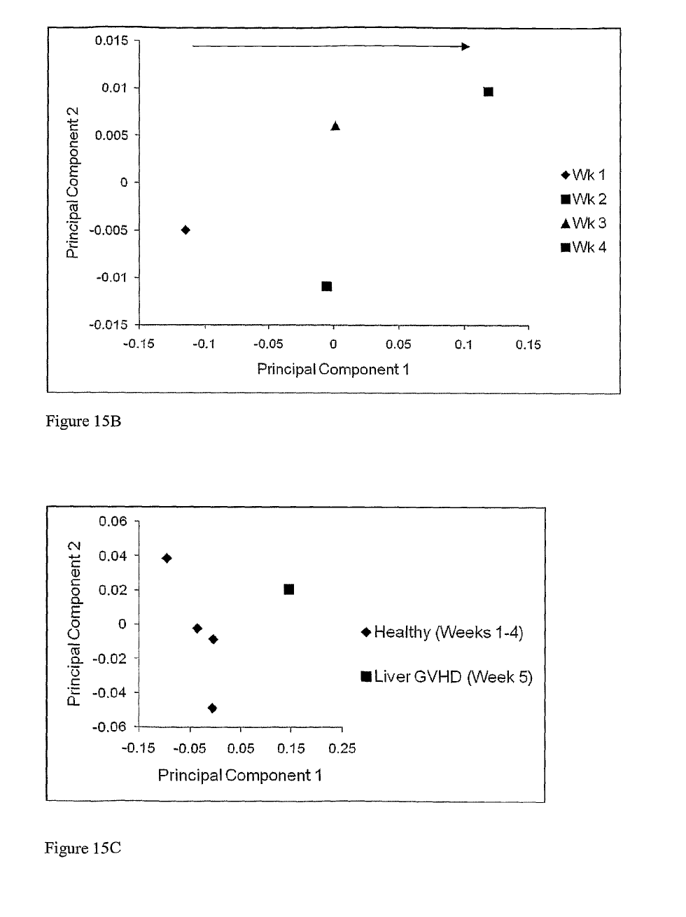

FIGS. 15A-C show results of a hierarchical classification of GVHD data. FIG. 15A shows the results of a PLS regression analysis on a data set including a larger number of patients than that illustrated in FIG. 14. Human plasma samples were collected from six haematopoietic stem cell transplant (HSCT) patients. Plasma samples were collected each week (post transplant) for a period of either 4-5 weeks (at which point the patient was released from hospital, N=4) or until the patient developed GVHD and entered intensive care (N=2). FIG. 15A highlights a PLS score plot of the first and second principal component scores obtained from a PLS analysis of the spectral region 1800-1490 cm⁻¹. Based on this analysis, spectra collected from two patients who developed GVHD are separated from spectra collected from patients who did not develop GVHD. The separation was achieved in spectra collected one week, and one and two weeks prior to the diagnosis of GVHD by other diagnostic procedures, respectively. In FIG. 15A, the open triangles represent spectra collected from Skin GVHD patient 2 in weeks 1, 2 and 3 post transplant, before any clinical or spectroscopic indications of GHVD.

FIG. 15B shows an example of a PLS analysis of the amide/C═O region (1800-1490 cm⁻¹) of spectra collected from human plasma over the time course of skin GVHD development. The results show a time-dependent increase of only the X-axis (component 1) during the development of GVHD. GHVD was clinically diagnosed in Week 5 post transplant.

FIG. 15C shows an example of a PLS analysis of The C—H stretching region (2800-3100 cm⁻¹) of spectra collected from human plasma over the time course of liver GVHD development. The results show a significant separation of plasma collected at week 5 (1 week prior to GVHD diagnosis).

To develop a classifier for GVHD, a training set of spectral data is derived from a group of patients who have had a bone marrow transplant (BMT). The subsequent clinical history of the group is monitored to associate a diagnosis with the respective spectra. Multivariate statistical analysis techniques, for example those described above, are applied to the spectra to determine a classifier.

The classifier may be used on the spectra of other patients who later undergo a transplant to diagnose the onset of GVHD.

In the GHVD samples the diagnoses were achieved at least 1 week before clinical diagnosis.

### EXAMPLE 4

### Parkinson's Disease

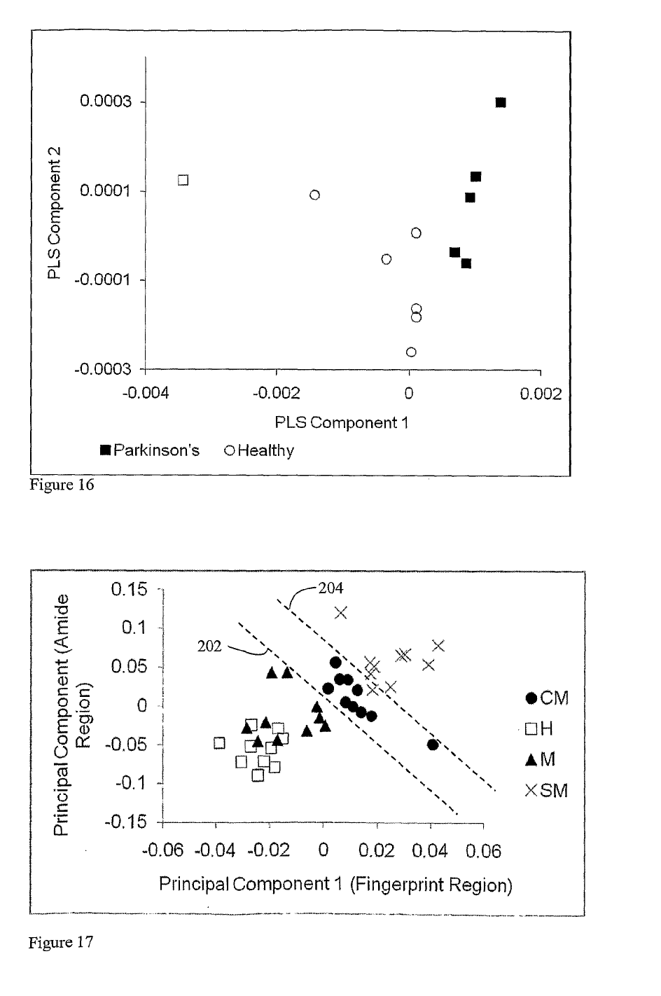

A similar approach has been used to analyse human serum collected from patients suffering Parkinson's disease (N=6) and age matched controls (N=6). All subjects were under the age of 80. FIG. 16 shows the PLS component 1 and component 2 scores plot obtained from a PLS analysis of the C—H stretching region from 2800-3100 cm⁻¹. Five of the patients suffering Parkinson's disease are shown to be separated to the right of the age-matched controls along the x-axis (principal component 1). However, one of the Parkinson's disease patients is shown to be separated to the left of the age matched controls along the x-axis. Comparison with clinical data revealed that this patient was suffering liver failure In addition to Parkinson's disease.

In neurodegenerative diseases, early diagnosis may be useful as appropriate treatment may slow the progression of the disease.

### EXAMPLE 5

### Diagnosis of Malaria from Human Plasma

The diagnosis procedure using vibrational spectral analysis and multivariate statistical analysis has also been applied to human serum.

FIG. 17 shows an example of a PLS Regression analysis of FTIR spectra collected from dried human plasma. The data set includes 10 patients with Cerebral Malaria (CM), 10 patients with Severe Malaria (SM), 10 patients with Mild Malaria (M) and 10 healthy controls (H). The illustrated PLS analysis uses the portion of the spectra measured in the fingerprint region (700-1490 cm⁻¹) and the C═O and amide region (1490-1800 cm⁻¹). FIG. 17 shows a plot of the first principal component from the fingerprint region on the x-axis and a principal component of the C═O and amide region on the 7-axis. Line 202 separates the data of patients who are healthy or have mild malaria from those patients who have severe malaria or cerebral malaria.

Line 204 serves generally to separate data of patients with cerebral, malaria from the patients with severe malaria. One sample point, of a patient with severe malaria, is classified with the cerebral malaria data. This severe malaria sample that clustered with the CM samples had a much higher white blood cell count than the other severe malaria samples. The CM sample that is separated to the bottom right of the figure although still between lines 202 and 204 had a much higher white blood cell count and a much lower red blood cell, count than the other CM patients.

The classifiers developed in the training phase, for example lines 202 and 204, may subsequently be used to assess new patients. To apply the classifiers, a blood sample is taken and centrifuged to obtain serum. This may take of the order of 5-10 minutes. The serum is pipetted and placed on a slide and the spectrum measured using the vibrational spectrometer 5. The spectrum is provided to a software classifier running, for example, on processor 9. Using the classifier illustrated in FIG. 17, the classifying algorithm proceeds as follows:
perform a PLS regression on the spectrum in the fingerprint region and record a score for the first principal component;
perform a PLS regression on the spectrum in the amide region and record the score for the principal component in the amide region;
determine the location of the point defined by the fingerprint score and the amide score (ie where the point would lie if plotted on the graph of FIG. 17).
if the point lies in the region to the left of line 202, the classifier concludes that the patient is healthy Or has mild malaria anaemia;
if the point lies between lines 202 and 204, the classifier concludes that the patient has cerebral malaria;
if the point lies to the right of line 204, the classifier concludes that the patient has severe malaria anaemia;
the conclusion of the classifier is displayed and may also be stored electronically.

The entire procedure from taking the blood sample to the display of the classifier conclusion may take of the order of 20 minutes, thus providing a rapid indication of the patient's status.

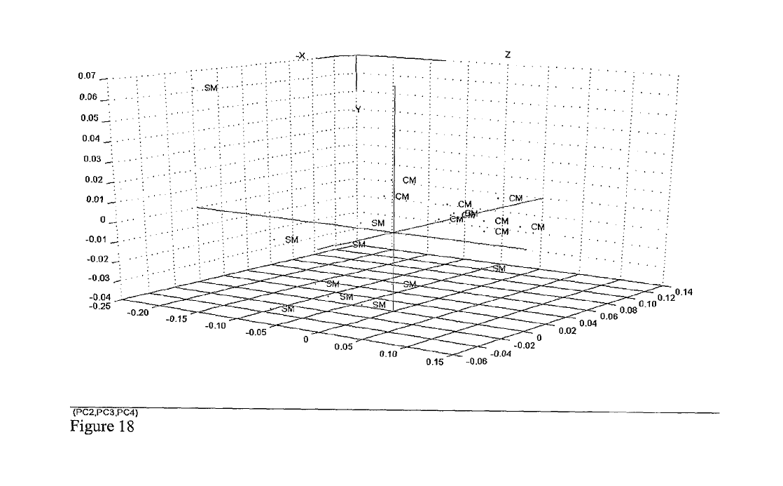

FIG. 18 shows an example of a 3D Principal component score plot (PC2, PC3, PC4), produced from PLS analyses of the C═O and amide regions (1800-1490 cm⁻¹) of human plasma, and which serves to distinguish between Severe Malaria (SM, n=10) and Cerebral Malaria (CM, n=10)).

Based on this data set, sensitivities and specificities of 90.9% and 100% for the diagnosis of cerebral malaria and 100% and 90.0% for severe malaria are achieved.

### EXAMPLE 6

### Use in General Screening

The foregoing examples describe the development of different classifiers that serve to distinguish between different sets of disease states. The results show that the classifiers may be effective before distinctive clinical symptoms are evident.

Consequently, a library of classifiers may be developed and added to as further classifiers become available. The library of classifiers may be organised in a hierarchical and/or sequential fashion.

If a patient presents with ill-defined symptoms, a blood test may be performed and vibrational spectra obtained. The library of classifiers may be applied to the spectra to quickly eliminate a range of possibilities, using hierarchical procedures in the software. The structured application of the library of classifiers may narrow the diagnosis down to a likely cause or a range of diseases for which further clinical investigations would be appropriate.

The methods and systems described herein may be used to distinguish many different conditions with similar clinical symptoms, where the conditions are associated with different blood chemistry. The methods are relatively rapid compared with many traditional diagnostic methods. A rapid clinical evaluation from a drop of blood may have enormous implications in emergency clinics in hospitals. In some arrangements the test and diagnosis may be performed in an ambulance as the patient is being transported to hospital.

The technique of using spectroscopic analysis of biological samples together with multivariate classification may also be used to detect and monitor the early onset of other diseases, including HIV. Another example is patients attending acute care with chest pains. It is known that people with chest pains associated with a heart condition have changes in blood chemistry if it is a mild heart attack, but this takes time to assess with traditional methods combined with various other diagnostics. A rapid test from a drop of blood may improve the efficacy of treatment.

The detected diseases may be caused by pathogens selected from the group consisting of viruses, bacteria and fungi.

The inventors hypothesise that during the development of numerous diseases, there are likely to be specific changes in a patient's metabolism due to various conditions of immune response and/or states of sickness/stress, that result in alteration of the chemical composition of biological fluids such as serum. These changes may be specific to the type of severity of disease. The methods and systems described herein use vibrational spectroscopy combined with multivariate analyses to detect these metabolic alterations (as well as alterations due to the presence of biochemical markers of the disease). It is believed that using this approach disease diagnosis may be achieved at much earlier stages in disease development, as well as achieving diagnosis for diseases that do not have current diagnostic methods (for example differentiation of cerebral malaria and bacterial meningitis).

It will be understood that the invention disclosed and defined in this specification extends to all alternative combinations of two or more of the individual features mentioned or evident from the text or drawings. All of these different combinations constitute various alternative aspects of the invention.

1. A method of classifying a sample of a biological fluid comprising:
(a) obtaining a spectrum of the biological fluid in response to excitation of the sample in a specified frequency range; and
(b) applying a multivariate classifier to one or more spectral regions of the spectrum to classify the biological sample into one class in a set of classes, the classes comprising at least two disease states having similar clinical symptoms.

2. A method according to claim 1 wherein the disease states are selected from the group consisting of:
bacterial meningitis;
cerebral malaria;
severe malaria anaemia;
mild malaria anaemia; and
healthy.

3. A method according to claim 1 wherein the disease states comprise viral meningitis and bacterial meningitis.

4. A method according to claim 1 wherein the disease states comprise:
graft-versus-host-disease (GVHD) and
healthy.

5. A method according to claim 4 wherein the GVHD disease state is early-stage GVHD prior to the presentation of clinical symptoms.

6. A method according to claim 2 wherein the disease states comprise:
Parkinson's disease; and
healthy.

7. A method according to claim 1 wherein the biological fluid comprises serum.

8. A method according to claim 1 wherein the biological fluid comprises plasma.

9. A method according to claim 1 wherein the specified frequency range is an infrared frequency range.

10. A method according to claim 1 wherein the step of obtaining a spectrum utilises at least one of Fourier Transform Infrared spectroscopy (FTIR) and Raman spectroscopy.

11. A method according to claim 1 wherein the spectral regions include at least one of:
a fingerprint spectral region between 550 and 1490 cm⁻¹;
a C═O stretching spectral region between 1700 and 1760 cm⁻¹;
an amide spectral region between 1490 and 1700 cm⁻¹; and
a C—H stretching spectral region between 2800 and 3100 cm⁻¹.

12. A method according to claim 1 wherein the multivariate classifier comprises a hierarchical classification and the method comprises:
applying a first classifier to the spectrum to classify the sample into one class in a first set of classes; and, if the one class represents a plurality of sub-classes
applying a second classifier to the spectrum to classify the sample into one of the sub-classes.

13. A method according to claim 12 wherein the first classifier classifies the sample into a sick class or a healthy class and the second classifier classifies samples from the sick class into i) a cerebral malaria class, ii) a bacterial meningitis class or iii) a severe malaria anaemia class.

14. A method of classifying a biological sample comprising:
(a) obtaining a spectrum of the biological sample in response to excitation of the sample in a specified frequency range; and
(b) applying a multivariate classifier to the spectrum to classify the biological sample into one class in a set of classes, the classes comprising at least one disease caused by a pathogen.

15. A method of classifying a sample of a biological fluid comprising:
(a) obtaining a spectrum of the biological fluid in response to excitation of the sample in a specified frequency range; and
(b) applying a multivariate classifier to a plurality of spectral regions of the spectrum, wherein the classifier assigns a score for the biological fluid in each of the spectral regions;
(c) classifying the biological fluid into one class in a set of classes dependent on the assigned scores, the classes comprising at least one disease state selected from the group consisting of bacterial meningitis, cerebral malaria, mild malaria anaemia, severe malaria anaemia and healthy.

16. A method according to claim 15 wherein the biological fluid is serum.

17. A method according to claim 15 wherein the spectral regions include at least one of:
a fingerprint spectral region between 550 and 1490 cm⁻¹ or part thereof;
a C═O stretching spectral region between 1700 and 1760 cm⁻¹ or part thereof;
an amide spectral region between 1490 and 1700 cm⁻¹ or part thereof; and
a C—H stretching spectral region between 2800 and 3100 cm⁻¹ or part thereof.

18. A method of classifying a sample of a biological fluid comprising:
(a) obtaining a spectrum of the biological fluid in response to excitation of the sample in a specified frequency range; and
(b) applying a multivariate classifier to a plurality of spectral regions of the spectrum, wherein the classifier assigns a score for the biological fluid in each of the spectral regions;
(c) classifying the biological fluid into one class in a set of classes dependent on the assigned scores, the classes comprising i) healthy and ii) early-stage GVHD prior to the presentation of clinical symptoms.

19. A method of classifying a sample of a biological fluid comprising:
(a) obtaining a spectrum of the biological fluid in response to excitation of the sample in at least one specified frequency range; and
(b) applying a multivariate classifier to the at least one frequency range, wherein the classifier assigns one or more scores for the biological fluid in the at least one frequency range;
(c) classifying the biological fluid into one class in a set of classes dependent on the assigned scores, the classes comprising i) healthy and ii) meningitis prior to the onset of clinical symptoms.

20. A method of classifying a sample of a biological fluid comprising:
(a) obtaining a spectrum of the biological fluid in response to excitation of the sample in a specified frequency range; and
(b) applying a multivariate classifier to a plurality of spectral regions of the spectrum, wherein the classifier assigns one or more scores for the biological fluid in each of the spectral regions;
(c) classifying the biological fluid into one class in a set of classes dependent on the assigned scores, the classes comprising i) healthy and ii) Parkinson's disease.

21. A method for rapidly diagnosing a malarial state of a patient, comprising:
(a) obtaining a blood sample from the patient;
(b) measuring a vibrational spectrum of serum from the blood sample;
(c) applying a multivariate classifier to a plurality of spectral regions of the vibrational spectrum, wherein the classifier assigns a score for the patient in each of the spectral regions;
(d) classifying the patient into one class in a set of malarial classes dependent on the assigned scores, the set of malarial classes comprising cerebral malaria, mild malaria anaemia, severe malaria anaemia and healthy.

22. A method of classifying a sample of a biological fluid to assess progression of a disease, the method comprising:
(a) obtaining a spectrum of the biological fluid in response to excitation of the sample in at least one specified frequency range; and
(b) applying a multivariate classifier to the at least one frequency range, wherein the classifier assigns one or more scores for the biological fluid in the at least one frequency range;
(c) classifying the biological fluid into one class in a set of classes dependent on the assigned scores, the classes comprising different stages of the disease.

23. A method according to claim 22 wherein the disease is meningitis.

24. A method according to claim 22 wherein the classes comprise a plurality of different diseases and, for at least one of the diseases, a plurality of classes indicative of different stages of the at least one disease.

25. A method according to claim 22 wherein the plurality of diseases includes cerebral malaria, severe malaria and bacterial meningitis.

26. A method of determining a multivariate classifier for classifying samples of a biological fluid, comprising:
(a) obtaining a spectrum in a specified frequency range of each of a plurality of training biological fluid samples in response to excitation of the training fluid samples ;
(b) associating a clinical characterisation with each of the spectra, wherein the clinical characterisation is drawn from a set comprising at least two disease states having similar clinical symptoms;
(c) performing a multivariate statistical analysis of a plurality of spectral regions of the spectra to identify distinguishing features of the spectra;
(d) defining a multivariable classifier that partitions the spectra into a plurality of classes dependent on the distinguishing features; and
(e) assessing whether the partitioning of the spectra by the multivariate classifier correlates to the respective clinical characterisations associated with the spectra.

27. A method according to claim 26 wherein step (d) comprises defining a hierarchical classifier having a first classifier that partitions the spectra into a first set of classes and a second classifier that partitions at least one class from the first set into a second set of classes.

28. A method according to claim 26 further comprising applying the multivariate classifier to at least one spectrum obtained from a clinical sample to classify the clinical sample.

29. A method according to any one of claim 26 wherein the set of clinical characterisations comprises at least two of:
bacterial meningitis;
cerebral malaria;
severe malaria anaemia;
mild malaria anaemia; and
healthy.

30. A method according to claim 26 wherein the set of clinical characterisations comprises viral meningitis and bacterial meningitis.

31. A method according to claim 26 wherein the set of clinical characterisations comprises GVHD and healthy.

32. A method according to claim 26 wherein the set of clinical characterisations comprises Parkinson's disease and healthy.

33. A method according to claim 26 wherein the set of clinical characterisations comprises different stages of a disease.

34. A method according to claim 33 wherein the disease is meningitis.

35. A method according to claim 26 wherein the set of clinical characterisations comprises a plurality of diseases and, for at least one of the diseases, a plurality of different stages of the at least one disease.

36. A method according to claim 35 wherein the plurality of diseases includes cerebral malaria, severe malaria and bacterial meningitis.

37. A method of determining a multivariate classifier for classifying biological samples, comprising:
(a) obtaining a spectrum of each of a plurality of training biological samples in response to excitation of the training samples in a specified frequency range;
(b) associating a clinical characterisation with each of the spectra, wherein the clinical characterisation is drawn from a set comprising at least one disease caused by a pathogen;
(c) performing a multivariate statistical analysis of the spectra to identify distinguishing features of the spectra;
(d) defining a multivariable classifier that partitions the spectra into a plurality of classes dependent on the distinguishing features; and
(e) assessing whether the partitioning of the spectra by the multivariate classifier correlates to the respective clinical characterisations associated with the spectra.

38. A method of determining a multivariate classifier for classifying biological samples dependent on at least one disease, comprising:
(a) obtaining a spectrum of each of a plurality of training biological samples in response to excitation of the training samples in a specified frequency range, the training samples including samples from subjects having the at least one disease;
(b) associating a clinical characterisation with each of the spectra;
(c) performing a multivariate statistical analysis of the spectra to remove variations in the plurality of training samples due to natural variations in the samples and identify distinguishing features dependent on the at least one disease;
(d) defining a multivariable classifier that partitions the spectra into a plurality of classes dependent on the distinguishing features; and
(e) assessing whether the partitioning of the spectra by the multivariate classifier correlates to the respective clinical characterisations associated with the spectra.

39. A method of determining a multivariate classifier for classifying samples of serum, comprising:
(a) obtaining a spectrum of each of a plurality of training serum samples in response to excitation of the training samples in an infrared specified frequency range, the training samples including samples from subjects having at least one disease state selected from the group consisting of acute bacterial meningitis, cerebral malaria, severe malaria anaemia, mild malaria anaemia and healthy;
(b) associating a clinical characterisation with each of the spectra;
(c) performing a multivariate analysis of the spectra to remove variations in the plurality of training samples due to natural variations in the samples and identify distinguishing features dependent on the at least one disease;
(d) defining a multivariable classifier that partitions the spectra into a plurality of classes dependent on the distinguishing features; and
(e) assessing whether the partitioning of the spectra by the multivariate classifier correlates to the respective clinical characterisations associated with the spectra.

40. A system for classifying a sample of a biological fluid comprising:
a spectrometer that provides a spectrum of the biological fluid in a specified frequency range; and
a processor having a multivariate classifier that in use is applied to one or more spectral regions of the spectrum to classify the biological sample into one class in a set of classes, the classes comprising at least two disease states having similar clinical symptoms.

41. A system according to claim 40 wherein the disease states are selected from the group consisting of:
bacterial meningitis;
cerebral malaria;
severe malaria anaemia;
mild malaria anaemia; and
healthy.

42. A system according to claim 40 wherein the disease states comprise viral meningitis and bacterial meningitis.

43. A system according to claim 40 wherein the disease states comprise:
graft-versus-host-disease (GVHD) and
healthy.

44. A system according to claim 40 wherein the disease states comprise:
Parkinson's disease; and
healthy.

45. A system according to claim 40 wherein the spectrometer utilises Fourier Transform Infrared (FTIR) spectroscopy.

46. A system according to claim 40 wherein the spectrometer utilises Raman spectroscopy.

47. A system according to claim 40 wherein the classifier is applied to spectral regions including at least one of:
a fingerprint spectral region between 550 and 1490 cm⁻¹;
a C═O stretching spectral region between 1700 and 1760 cm⁻¹;
an amide spectral region between 1490 and 1700 cm⁻¹; and
a C—H stretching spectral region between 2800 and 3100 cm⁻¹.

48. A system according to claim 40 wherein the multivariate classifier comprises a hierarchical classification that:
applies a first classifier to the spectrum to classify the sample into one class in a first set of classes; and, if the one class represents a plurality of sub-classes
applies a second classifier to the spectrum to classify the sample into one of the sub-classes.

49. A system according to claim 48 wherein the first classifier classifies the sample into a sick class or a healthy class and the second classifier classifies samples from the sick class into i) a cerebral malaria class, ii) a bacterial meningitis class or iii) a severe malaria anaemia class.

50. A computer program product comprising machine-readable instructions recorded on a machine-readable recording medium, for controlling the operation of a data processing apparatus on which the instructions execute to perform a method according to claim 1.

51. A computer program comprising machine-readable instructions for controlling the operation of a data processing apparatus on which the instructions execute to perform a method according to claim 1.
